(19) United States
(12) Patent Application Publication
(10) Pub. No.: US 2021/0263639 A1
(43) Pub. Date: Aug. 26, 2021

(54) ELECTRONIC DEVICE SHARING AT LEAST ONE OBJECT AND METHOD FOR CONTROLLING THE SAME

(71) Applicant: Samsung Electronics Co., Ltd., Gyeonggi-do (KR)

(72) Inventors: Eunkyung LEE, Gyeonggi-do (KR); Eunseok KIM, Gyeonggi-do (KR); Eunsun KIM, Gyeonggi-do (KR); Jaehee MOON, Gyeonggi-do (KR)

(21) Appl. No.: 17/179,519

(22) Filed: Feb. 19, 2021

(30) Foreign Application Priority Data
Feb. 21, 2020 (KR) 10-2020-0021375

(51) Int. Cl. G06F 3/0484; G06F 3/0488

(52) U.S. Cl. CPC G06F 3/04842; G06F 3/0488

(57) ABSTRACT

An electronic device and method are disclosed. The electronic device includes a communication circuit, a touchscreen display, and a processor. The processor implements the method, including: receiving a request to share at least one object via the touchscreen display, identify at least one external electronic device proximate to the electronic device in response to receiving the request, displaying, via the touchscreen display, at least one indicator representing the identified at least one external electronic device, wherein when a plurality of external electronic devices are identified, a plurality of representative indicators are displayed according to a predetermined priority, detecting a selection of the at least one indicator via the touchscreen display, and in response to detecting the selection of the at least one indicator, transmitting the at least one data object to the identified at least one external electronic device via the communication circuit.

### CROSS-REFERENCE TO RELATED APPLICATION(S)

This application is based on and claims priority under 35 U.S.C. 119 to Korean Patent Application No. 10-2020-0021375, filed on Feb. 21, 2020, in the Korean Intellectual Property Office, the disclosure of which is herein incorporated by reference in its entirety.

### TECHNICAL FIELD

The disclosure relates to networking between electronic devices, and more particular, to user interface techniques for sharing data to a target electronic device.

### BACKGROUND

More and more services and functions are provided through electronic devices, e.g., smartphones, or other portable electronic devices. To meet the needs of various users and increase usage efficiency of electronic devices, communication service carriers and device manufacturers are pushing into the competitive development of electronic devices with differentiated and diversified functionalities, resulting in the growth and advancement of the related technologies.

### SUMMARY

An electronic device such as a smart phone may transmit and receive information using short-range communication (e.g., ultra-wide band “UWB” communication). To share at least one data object, various user interfaces for sharing may be provided through an electronic device to the user. For the user's convenience, a user interface may intuitively indicate a location and direction of a recipient target device of the data object. In accordance with an embodiment, an electronic device is disclosed, including a communication circuit, a touchscreen display, and a processor, configured to: receive a request to share at least one object via the touchscreen display, identify at least one external electronic device proximate to the electronic device in response to receiving the request, display, via the touchscreen display, at least one indicator representing the identified at least one external electronic device, wherein when a plurality of external electronic devices are identified, a plurality of representative indicators are displayed according to a predetermined priority, detect a selection of the at least one indicator via the touchscreen display, and in response to detecting the selection of the at least one indicator, transmit the at least one data object to the identified at least one external electronic device via the communication circuit.

In accordance with an embodiment, a method for controlling an electronic device is disclosed, comprising receiving a request to share at least one object via a touchscreen display of the electronic device, identifying, by at least one processor, at least one external electronic device proximate to the electronic device in response to receiving the request, displaying, via the touchscreen display, at least one indicator representing the at least one external electronic device, wherein when a plurality of external electronic devices are identified, a plurality of representative indicators are displayed according to a predetermined priority, detecting a selection of the at least one indicator via the touchscreen display, and in response to detecting the selection of the at least one indicator, transmitting the at least one data object to the identified at least one external electronic device via a communication circuit of the electronic device.

Other aspects, advantages, and salient features of the disclosure will become apparent to those skilled in the art from the following detailed description, which, taken in conjunction with the annexed drawings, discloses example embodiments of the disclosure.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a block diagram illustrating an electronic device in a network environment according to an embodiment;

FIGS. 2A, 2B, 2C, 2D, 2E, 2F, 2G, 2H, 2I, 2J, 2K, 2L, 2M, 2N, 2O, 2P, 2Q, 2R, 2S, 2T, and 2U are views illustrating the function or operation of providing location information about an external electronic device around an electronic device according to an embodiment;

FIGS. 3A, 3B, 3C, and 3D are views illustrating the function or operation of providing information about a transmission state when an electronic device transmits an object to an external electronic device according to an embodiment;

FIGS. 4A, 4B, 4C, 4D, 4E, 4F, 4G, 4H, 4I, 4J, and 4K are views illustrating the function or operation of providing different user interfaces depending on the type of an external electronic device according to an embodiment;

FIGS. 5A, 5B, and 5C are views illustrating the function or operation of applying a visual effect to an indicator and providing the same, depending on the number of transmissions of a predetermined object for an external electronic device according to an embodiment;

FIGS. 6A, 6B, 6C, 6D, 6E, 6F, 6G, and 6H are views illustrating the function or operation of providing an indicator when there are a plurality of electronic devices adjacent to each other, according to an embodiment;

FIGS. 7A, 7B, 7C, 7D, and 7E are views illustrating the function or operation of executing a contacts application after an electronic device transmits a predetermined object to an external electronic device according to an embodiment;

FIGS. 8A, 8B, 8C, and 8D are views illustrating the function or operation of providing at least one user interface which is provided when an electronic device transmits predetermined objects to a plurality of external electronic devices according to an embodiment; and

FIGS. 9A, 9B, 9C, 9D, 9E, 9F, 9G, and 9H are views illustrating the function or operation of an electronic device providing information about the location and direction of an external electronic device using a plurality of indicators according to an embodiment.

Throughout the drawings, like reference numerals will be understood to refer to like parts, components, and structures.

### DETAILED DESCRIPTION

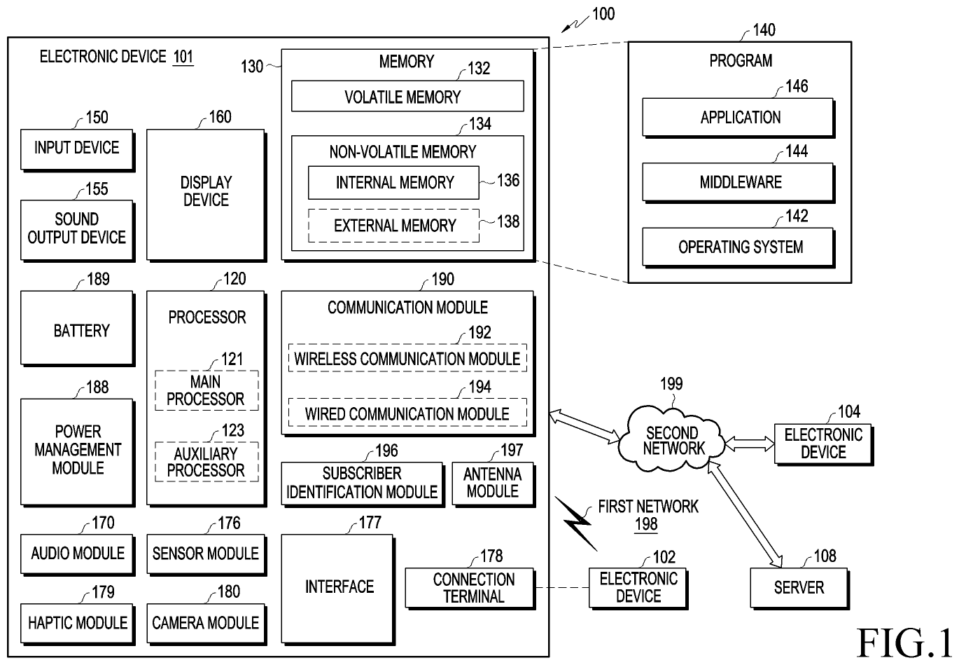

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device). According to an embodiment, the antenna module may include one antenna including a radiator formed of a conductor or conductive pattern formed on a substrate (e.g., a printed circuit board (PCB)). According to an embodiment, the antenna module 197 may include a plurality of antennas. In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

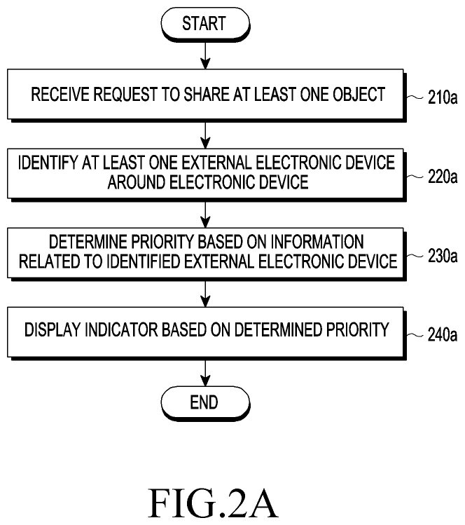

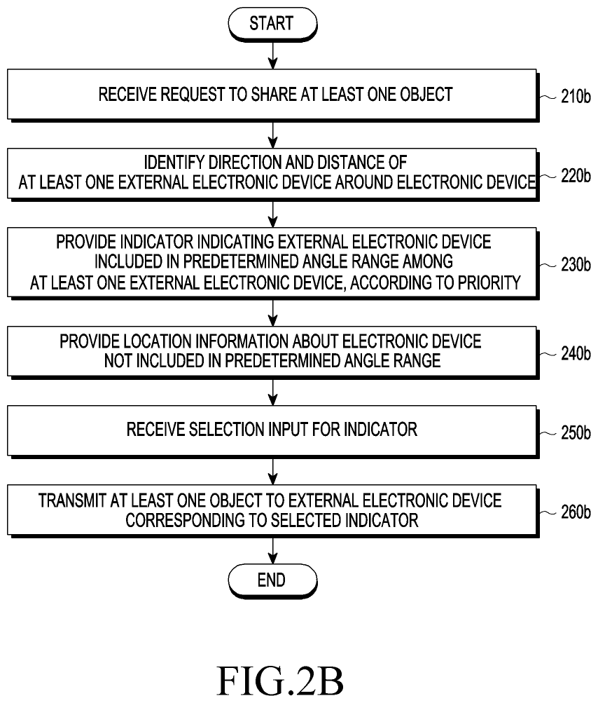

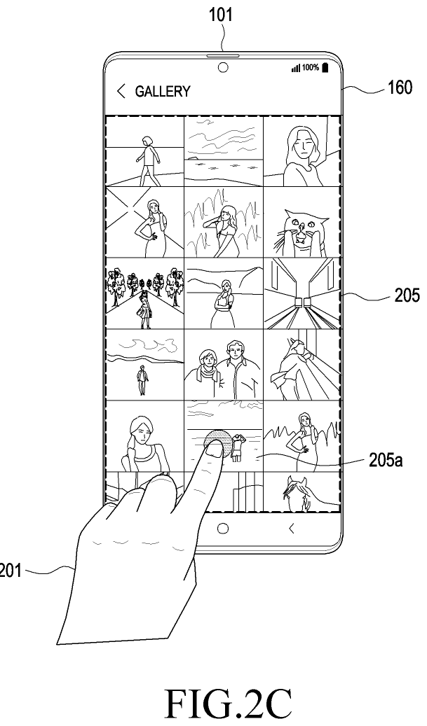

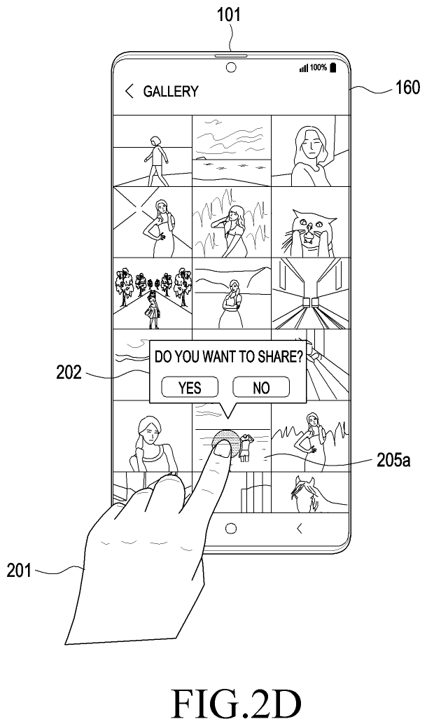

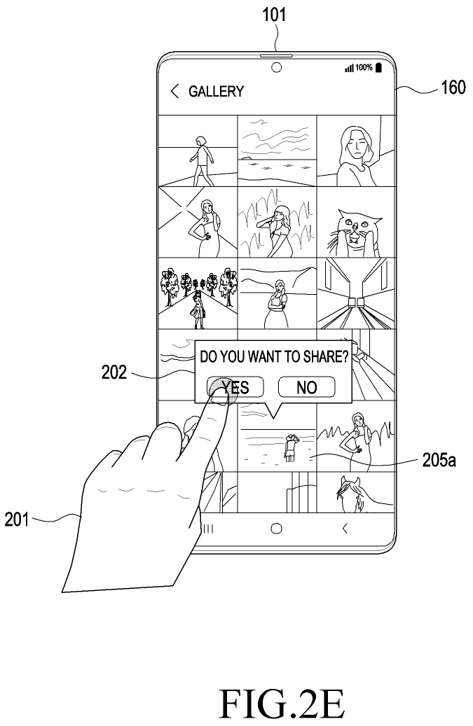

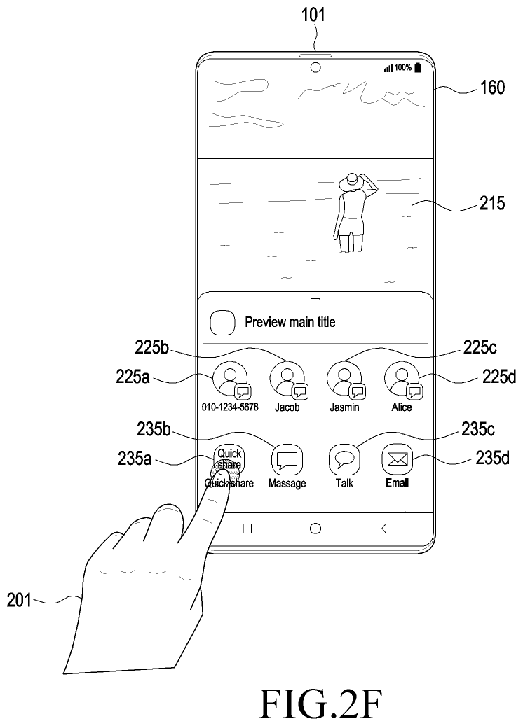

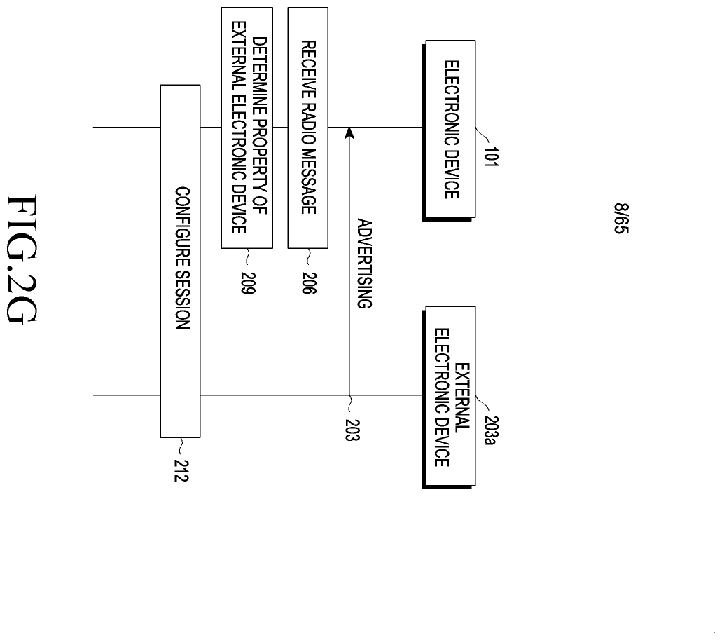

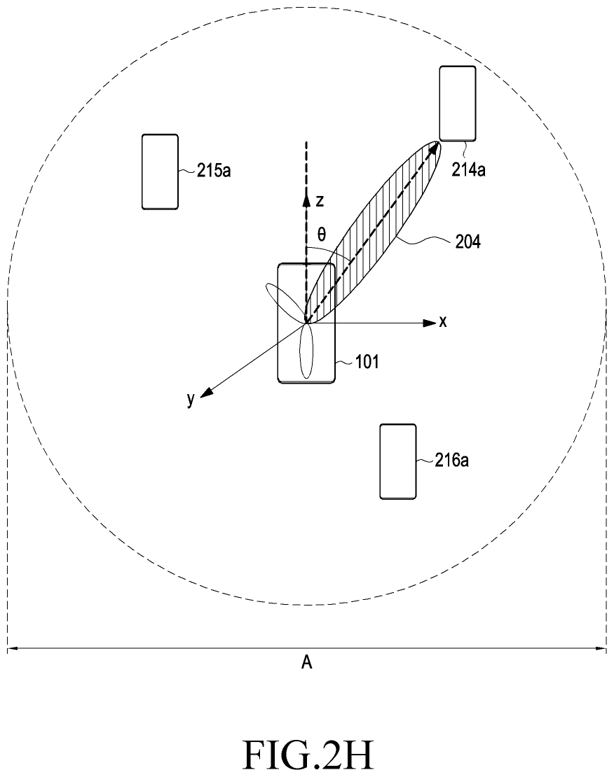

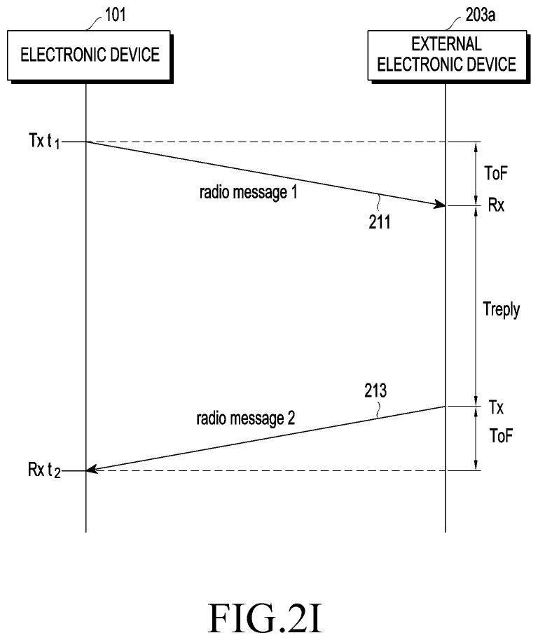

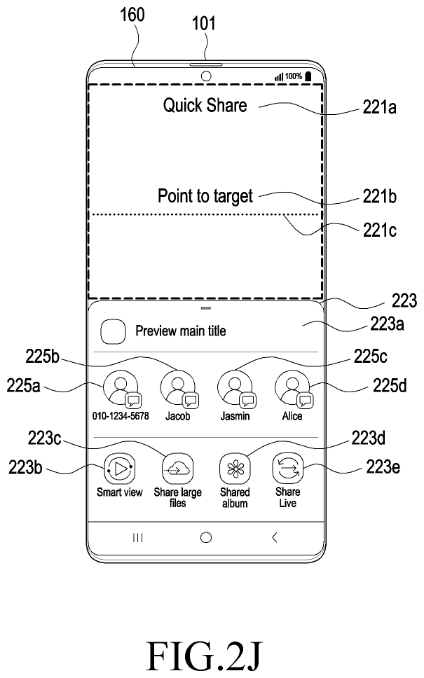

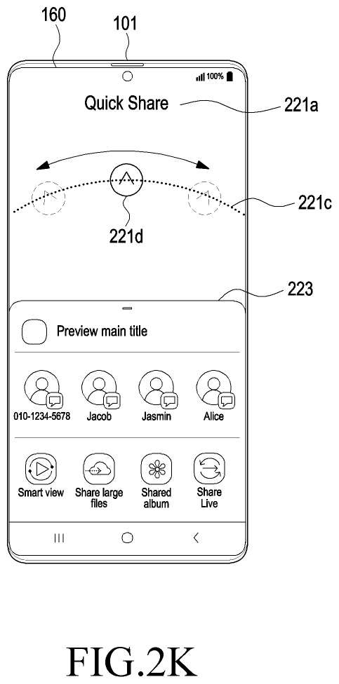

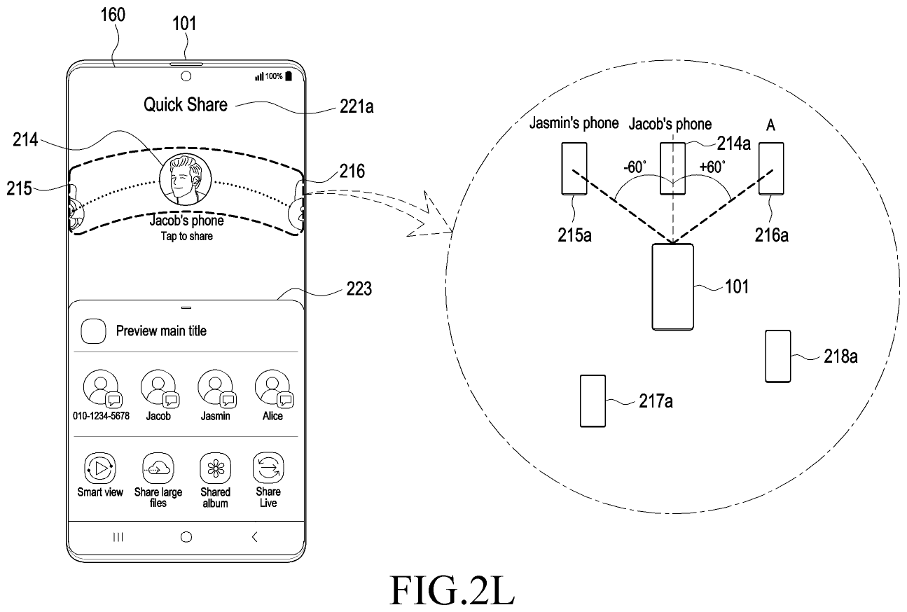

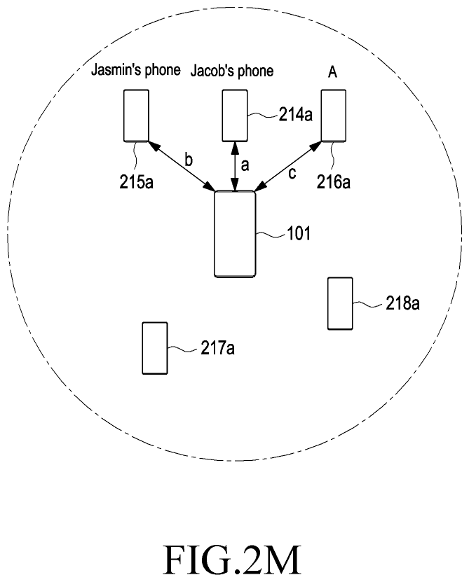

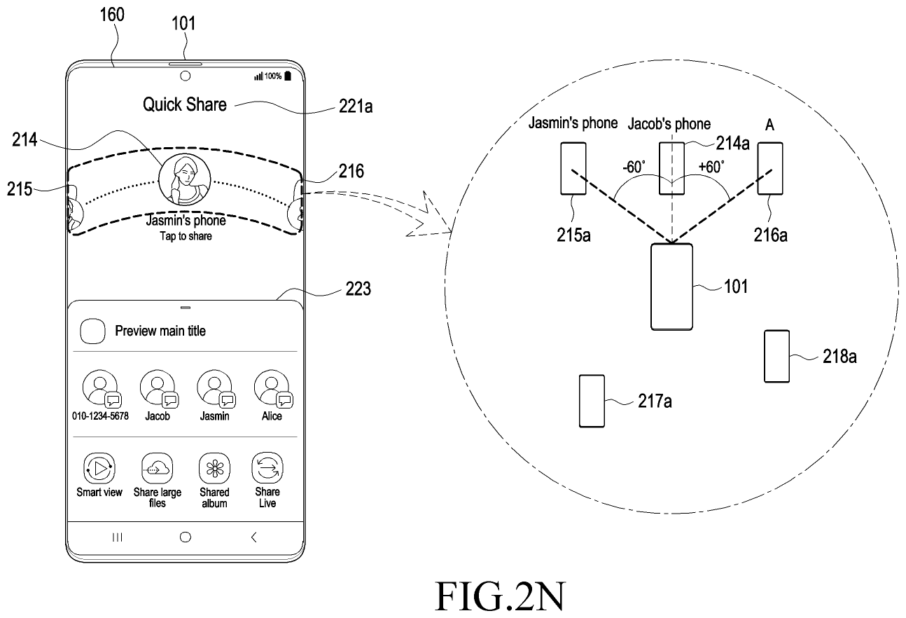

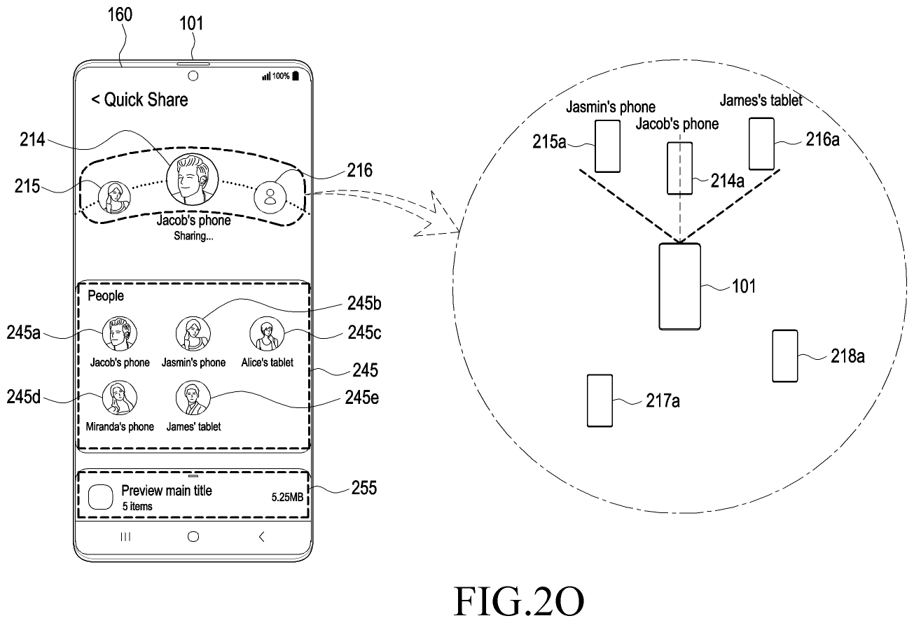

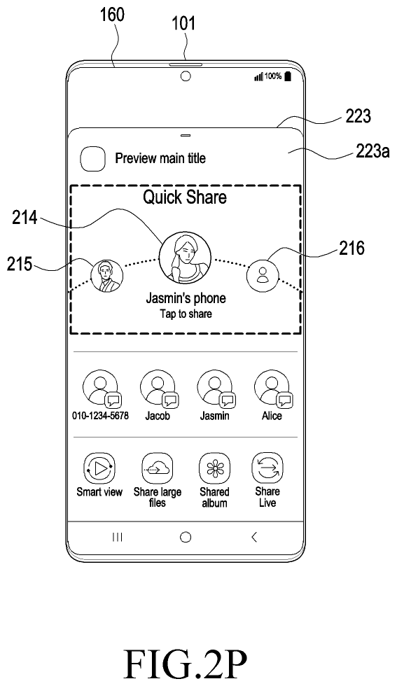

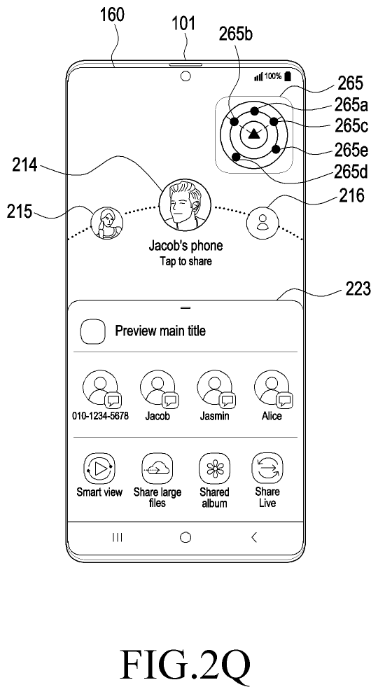

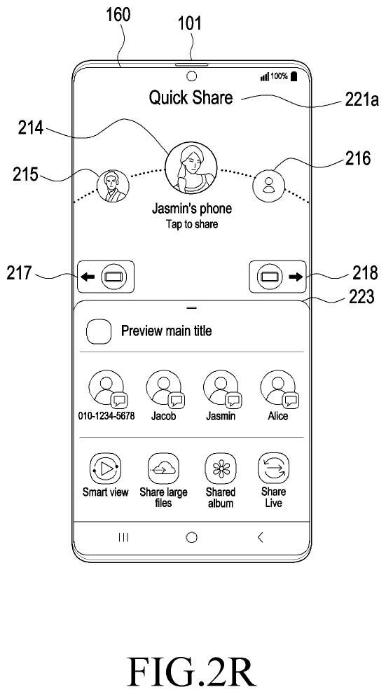

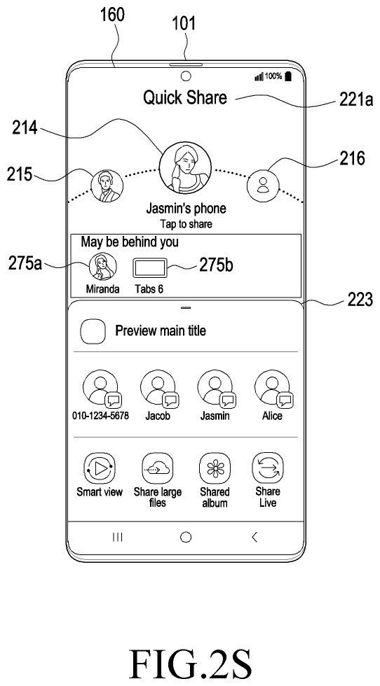

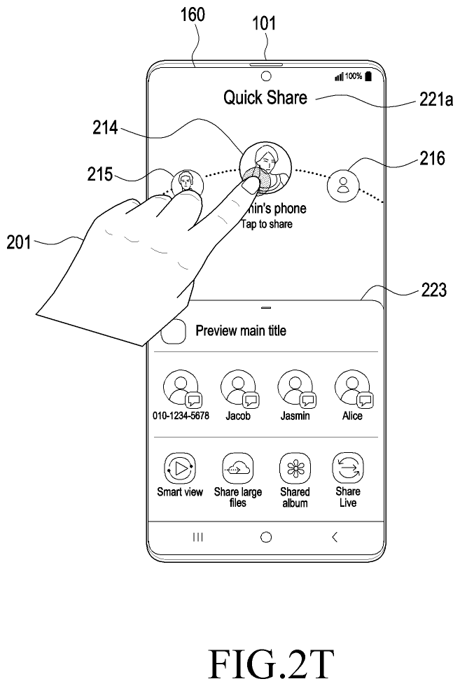

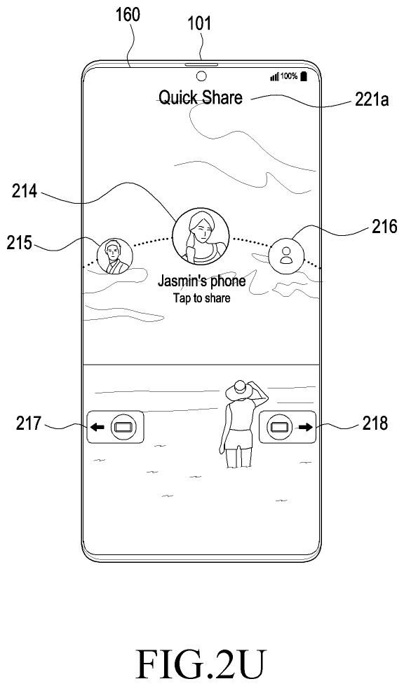

FIGS. 2A, 2B, 2C, 2D, 2E, 2F, 2G, 2H, 2I, 2J, 2K, 2L, 2M, 2N, 2O, 2P, 2Q, 2R, 2S, 2T, and 2U are views illustrating the function or operation of providing location information about an external electronic device around an electronic device according to an embodiment.

Referring to FIG. 2A, according to an embodiment, an electronic device (e.g., the electronic device 101 of FIG. 1) may receive a request to share at least one data object in operation 210a. According to an embodiment, the at least one object may include various formats of data files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify at least one external electronic device proximate to the electronic device in operation 220a, or otherwise nearby within a threshold communicable range. According to an embodiment, the electronic device (e.g., the electronic device 101 of FIG. 1) may identify the presence of the external electronic device by receiving a radio message “advertised” (e.g., announced) by the external electronic device in a broadcasting scheme. According to an embodiment, the electronic device may identify the direction and/or distance of at least one external electronic device around the electronic device (e.g., the electronic device 101 of FIG. 1). According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device.

According to an embodiment, the electronic device (e.g., the electronic device 101 of FIG. 1) may determine a priority based on information related to the identified external electronic device in operation 230a. According to an embodiment, the priority may include the priority for displaying indicators corresponding to multiple external electronic devices (e.g., a representative indicator 214, a first candidate indicator 215, and/or a second candidate indicator 216 of FIG. 2L) for sharing at least one data object. According to an embodiment, the priority may include the distance from the electronic device 101, whether the external electronic device is fully included in the predetermined angle range, a sharing history (e.g., whether the number of sharing requests is a predetermined number or more (e.g., whether it is a terminal that frequently shares the object), the time of sharing a predetermined object (e.g., the external electronic device that has shared the predetermined object most recently)), whether the external electronic device is a device known to the electronic device (e.g., the electronic device 101 of FIG. 1) (e.g., whether identification information about the external electronic device (e.g., the phone number of the external electronic device) is stored in the electronic device), and/or a property of the object to be shared (e.g., whether the shared object is a video file or text file). According to an embodiment, the electronic device (e.g., the electronic device 101 of FIG. 1) may display an indicator for some of the plurality of external electronic devices. For example, when five external electronic devices are located in the predetermined angle range, the electronic device (e.g., the electronic device 101 of FIG. 1) may display only three indicators corresponding to three external electronic devices closer to the electronic device 101. In this case, the external electronic device closest to the electronic device 101 may be displayed as a representative indicator. According to an embodiment, the electronic device 101 may display only three indicators corresponding to three external electronic devices which have a larger number of times of sharing. In this case, the external electronic device which most shares with the electronic device 101 may be displayed as a representative indicator.

According to an embodiment, in operation 240a, the electronic device (e.g., the electronic device 101 of FIG. 1) may display at least one indicator (e.g., the representative indicator 214, the first candidate indicator 215, and/or the second candidate indicator 216 of FIG. 2L) indicating at least one external electronic device. In cases where there are multiple candidate devices, they may be displayed or otherwise listed based on the priority determined in operation 230a. However, if there is a single external electronic device instead of a plurality, it is understood that the steps pertaining to priority may be omitted.

Referring to FIG. 2B, according to an embodiment, an electronic device (e.g., the electronic device 101 of FIG. 1) may receive a request to share at least one object in operation 210b. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device communicably near or proximate to the electronic device (e.g., the electronic device 101 of FIG. 1) in operation 220b. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device. According to an embodiment, the external electronic device may be an electronic device supporting a predetermined communication scheme (e.g., short-range communication) and may mean an electronic device capable of transmitting at least one object.

According to an embodiment, the electronic device (e.g., the electronic device 101 of FIG. 1) may display an indicator indicative of an external electronic device in operation 230b. The indicator may be displayed in consideration of a real world location of the external electronic device, relative to a predetermined angle range centered on a particular surface of the device (e.g., a back surface of the device). According to an embodiment, the electronic device (e.g., the electronic device 101 of FIG. 1) may provide (e.g., display) an indicator corresponding to an external electronic device disposed within the predetermined angle (e.g., 120 degrees, i.e., 60 degrees to the left and 60 degrees to the right) from the particular surface of the electronic device (e.g., the side, front of back surface of electronic device 101 of FIG. 1) (e.g., the direction in which the electronic device 101 faces the external electronic device).

According to an embodiment, the electronic device (e.g., the electronic device 101 of FIG. 1) may provide location information about an external electronic device not included in (e.g., disposed outside of) the predetermined angle range (e.g., 120 degrees) in operation 240b. According to an embodiment, the electronic device (e.g., the electronic device 101 of FIG. 1) may provide location information about an external electronic device not included in the predetermined angle range (e.g., 120 degrees) via at least one of a mini-map, a user interface (e.g., an arrow) with directivity, or a guide message. Thus, it is possible to inform the user of the presence of an external electronic device not shown to the user.

According to an embodiment, the electronic device (e.g., the electronic device 101 of FIG. 1) may receive a selection input for the indicator in operation 250b. According to an embodiment, the electronic device (e.g., the electronic device 101 of FIG. 1) may receive a selection of the indicator via detection of a user gesture (e.g., a touch gesture) on the indicator.

According to an embodiment, the electronic device (e.g., the electronic device 101 of FIG. 1) may transmit at least one data object to the external electronic device corresponding to the selected indicator in operation 260b. According to an embodiment, the at least one object may be transmitted to the external electronic device via, e.g., short-range communication. According to an embodiment, the short-range communication may include various communication schemes, such as ultrawide band (UWB) communication, Bluetooth, or Wi-Fi direct. According to an embodiment, the electronic device may transmit at least one object to a predetermined external electronic device via the configured session in operation 220b.

FIGS. 2C to 2F are views illustrating the function or operation of the electronic device 101 receiving a request to share at least one object according to an embodiment.

Referring to FIG. 2C, according to an embodiment, the electronic device 101 may display a plurality of objects 205 (e.g., images) on the display device 160. According to an embodiment, the electronic device 101 may receive a selection input for at least one object 205a among the plurality of objects 205 from the user 201. Referring to FIG. 2D, according to an embodiment, the electronic device 101 may output a first notification message 202 (e.g., “Do you want to share?”) according to the reception of the selection input from the user 201. According to an embodiment, the input from the user 201 may be maintained while the first notification message 202 is being displayed. Referring to FIG. 2E, according to an embodiment, the electronic device 101 may receive a selection input (e.g., “yes”) for the first notification message 202 from the user. Referring to FIG. 2F, according to an embodiment, the electronic device 101 may display a screen for sharing at least one object 205a with the external electronic device according to the selection input from the user 201. According to an embodiment, an indicator 215 (e.g., an image) regarding the object to be transmitted may be displayed on the screen. According to an embodiment, user interfaces (e.g., a first user interface 225a, a second user interface 225b, a third user interface 225c, and/or a fourth user interface 225d) for transmitting at least one object to be shared, as a text message, to a predetermined party using a messaging application may be displayed on the screen. According to an embodiment, the screen may include a fifth user interface 235a indicating the electronic device 101 and a sharing scheme to share objects with the electronic device 101, a sixth user interface 235b for executing a messaging application, a seventh user interface 235c for executing a social media service application, and/or an eighth user interface 235d for executing an email application, using a predetermined communication scheme (e.g., a UWB communication scheme).

FIG. 2G is a view illustrating the operation of the electronic device 101 receiving information about an external electronic device 203a from the external electronic device 203a and configuring a session with the external electronic device 203a. According to an embodiment, the electronic device 101 may receive a radio message broadcast from the external electronic device 203a in operations 203 and 206. According to an embodiment, the radio message may be broadcast from the external electronic device 203a. According to an embodiment, the radio message may include at least one of the model name of the external electronic device 203a, the manufacturer of the external electronic device 203a, the name of a device configured by the user for the external electronic device 203a, the type of short-range communication supported by the external electronic device 203a, the device type of the external electronic device 203a (e.g., whether the device is a TV), or information (e.g., account ID or profile photo of the account) about the account currently logged in by the external electronic device 203a. According to an embodiment, the electronic device 101 may determine the properties of the external electronic device using information contained in the received radio message in operation 209. According to an embodiment, the properties of the external electronic device 203a may include information as to whether the external electronic device 203a supports a specific type of communication scheme (e.g., UWB communication scheme). According to an embodiment, in operation 212, the electronic device 101 may configure a session with the external electronic device 203a when the external electronic device 203a supports a specific type of communication scheme (e.g., UWB communication scheme). According to an embodiment, after the session is configured, the radio message may be transmitted/received between the electronic device 101 and the external electronic device 203a via the configured session. In this case, the radio message advertised via broadcast in operation 203 may include only information about the specific communication scheme supported by the external electronic device 203a among the pieces of information contained in the radio message mentioned above.

FIG. 2H is a view illustrating the function or operation of the electronic device 101 identifying the directions in which a plurality of external electronic devices (e.g., a first external electronic device 214a, a second external electronic device 215a, and a third external electronic device 216a) are located, according to an embodiment. According to an embodiment, the electronic device 101 may output directional beams (204) successively in all directions (e.g., 360-degree directions) depending on a specific angle θ with respect to the front surface of the electronic device 101. According to an embodiment, when data communication with an external electronic device (e.g., the first external electronic device 214a) is performed using the output directional beam, it may be determined that the external electronic device (e.g., the first external electronic device 214a) is located in a specific angle θ direction. According to an embodiment, the electronic device 101 may determine the direction in which the external electronic device (e.g., the first external electronic device 214a) is located, using various schemes (e.g., reception of global positioning system (GPS) data by the first external electronic device 214a) for determining the direction in which the external electronic device (e.g., the first external electronic device 214a) is located.

FIG. 2I is a view illustrating the function or operation of the electronic device 101 identifying the distance from the external electronic device 203a according to an embodiment. Referring to FIG. 2I, according to an embodiment, the electronic device 101 may transmit a first radio message to the external electronic device 203a in operation 211. In this case, according to an embodiment, the first radio message may be transmitted via a session configured between the electronic device 101 and the external electronic device 203a. According to an embodiment, in operation 213, the electronic device 101 may receive a second radio message corresponding to the first radio message, a predetermined time after the first radio message is received by the external electronic device 203a. According to an embodiment, the second radio message may include information regarding a predetermined time (e.g., Treply). According to an embodiment, the electronic device 101 may calculate the time-of-flight (ToF) value using Equation 1 below. According to an embodiment, since the electronic device 101 is aware of information regarding the transmission speed of the radio message (e.g., the first radio message), it is possible to calculate the distance between the electronic device 101 and the external electronic device 203a using the transmission speed-related information and the calculated ToF value.

$$ToF = \frac{{t}_{2} - {t}_{1} - {T}_{reply}}{2} \qquad [ Equation 1 ]$$

Referring to FIG. 2J, according to an embodiment, upon receiving a selection input to the fifth user interface 235a (from FIG. 2F), the electronic device 101 may display a screen for sharing at least one object on the display device 160. According to an embodiment, the screen for sharing at least one object may include the name (e.g., “Quick Share”) 221a of the sharing scheme, a first guide message 221b for guiding the user to the operation (e.g., lifting the electronic device 101) for starting to search for an external electronic device (e.g., the first external electronic device 214a), and a ninth user interface 221c for indicating that a search for an external electronic device (e.g., the first external electronic device 214a) is underway. According to an embodiment, the sharing scheme name 221a, the first guide message 221b, and the ninth user interface 221c may be displayed in a first region 221 of the screen for sharing at least one object. According to an embodiment, the first region may include the entire region, or only a portion, of the display device 160. According to an embodiment, the screen for sharing at least one object may include a share sheet 223 where various user interfaces utilized for sharing at least one object are displayed. According to an embodiment, the share sheet 223 may include the first user interface 225a, the second user interface 225b, the third user interface 225c, and/or the fourth user interface 225d. According to an embodiment, the share sheet 223 may display a tenth user interface 223b for executing a screen mirroring function or operation, an eleventh user interface 223c for storing large files in a cloud server, a twelfth user interface 223d for storing objects to be shared in a cloud server (e.g., a shared album), and/or a thirteenth user interface 223e for sharing at least one object with a plurality of external electronic devices. According to an embodiment, the share sheet 223 may be displayed to, or not to, overlap the first region 221.

FIG. 2K is a view illustrating user interfaces displayed on the electronic device 101 while searching for devices around the electronic device 101 when the user lifts the electronic device 101. Referring to FIG. 2K, according to an embodiment, the electronic device 101 may be lifted by the user to search for at least one external electronic device around the electronic device 101. However, such a triggering condition is merely an example. The electronic device 101 may start to search for peripheral devices according to the user's selection input on a user interface (not shown) for searching for peripheral devices. According to an embodiment, the electronic device 101 may display a first indicator 221d that continuously moves left to right to indicate that a search for external electronic devices located around the electronic device 101 (e.g., within a radius of 6 m from the electronic device 101) is underway. According to an embodiment, the ninth user interface 221c may be warped in predetermined curvature and displayed when the electronic device 101 starts to search for an external electronic device. According to an embodiment, even when a search for an external electronic device around the electronic device 101 is being conducted, the share sheet 223 may be displayed on the display device 160. According to an embodiment, when the user lifts the electronic device 101, the electronic device 101 according to an embodiment may execute a camera application. According to an embodiment, the screen captured by the camera may be displayed in at least a portion of the display device 160.

FIGS. 2L and 2M are views illustrating the function or operation of displaying, by the electronic device 101, a representative indicator 214 and candidate indicators (e.g., a first candidate indicator 215 and a second candidate indicator 216). Referring to FIG. 2L, according to an embodiment, the electronic device 101 may display the indicators corresponding to electronic devices (e.g., the first external electronic device 214a, the second external electronic device 215a, and the third external electronic device 216a) included within the predetermined angle (e.g., 120 degrees) of the device, as the representative indicator 214 and the candidate indicators 215 and 216. According to an embodiment, the external electronic device corresponding to the representative indicator 214 may be determined depending on a predetermined priority. According to an embodiment, the priority may include the distance from the electronic device 101, whether the external electronic device is fully included in the predetermined angle range, whether the number of sharing requests is a predetermined number or more and/or the properties (e.g., whether the target to be shared is a video file or text file) of the object to be shared. For example, according to an embodiment, any one (e.g., the first external electronic device 214a) closest to the electronic device 101 among at least one external electronic device (e.g., the first external electronic device 214a, the second external electronic device 215a, and the third external electronic device 216a) included in a predetermined angle range may be determined to be the external electronic device corresponding to the representative indicator 214. For example, according to an embodiment, at least one (e.g., the first external electronic device 214a) fully included in the predetermined angle range among at least one external electronic device (e.g., the first external electronic device 214a, the second external electronic device 215a, and the third external electronic device 216a) included in a predetermined angle range may be determined to be the external electronic device corresponding to the representative indicator 214. According to an embodiment, whether it is fully included in the predetermined angle range may be determined based on whether an external electronic device is included in a predetermined first angle range (e.g., 108 degrees (within 54 degrees to the left and 54 degrees to the right with respect to the front surface) which is smaller than the predetermined angle range (e.g., 120 degrees). For example, when the external electronic device is positioned in the direction in which it faces at 54 degrees to the right with respect to the front surface, the external electronic device is regarded as included in the predetermined first angle range (e.g., 108 degrees), and the electronic device 101 may determine that the external electronic device is fully included in the predetermined angle range. As another example, when the external electronic device is positioned in the direction in which it faces at 55 degrees to the right with respect to the front surface, the external electronic device is regarded as positioned out of the predetermined first angle range (e.g., 108 degrees), and the electronic device 101 may determine that only part of the external electronic device is positioned in the predetermined angle range (e.g., 120 degrees). According to an embodiment, the external electronic device which frequently transmits a predetermined object is determined to be the external electronic device corresponding to the representative indicator 214. According to an embodiment, although an external electronic device (e.g., a speaker) is positioned closest to the electronic device 101, if the object to be shared is a text file, another external electronic device (e.g., a smartphone) may be determined to be the external electronic device corresponding to the representative indicator 214. Referring to FIGS. 2L and 2M, the first external electronic device 214a is an external electronic device positioned closest to the electronic device 101 and fully included in the predetermined angle range, and the first external electronic device 214a may be determined to be the external electronic device corresponding to the representative indicator 214. In FIG. 2M, distance a may be shorter than distances b and c. According to an embodiment, the electronic device 101 may display the user's profile photo as the representative indicator 214. According to an embodiment, the user's profile photo may be transmitted from the first external electronic device 214a or a cloud server or may be stored in the electronic device 101. According to an embodiment, a nickname (e.g., “Jacob's phone”) of the first external electronic device 214a may be displayed around the representative indicator 214, as shown in FIG. 2L. According to an embodiment, the electronic device 101 may display the candidate indicators 215 and 216, along with the representative indicator 214. According to an embodiment, the candidate indicators 215 and 216 may be displayed based on the location and direction of the external electronic devices (e.g., the second external electronic device 215a and the third external electronic device 216a) individually corresponding to the candidate indicators 215 and 216. For example, the external electronic devices (e.g., the second external electronic device 215a and the third external electronic device 216a) individually corresponding to the candidate indicators 215 and 216 are partially included in a predetermined angle range. Thus, as shown in FIG. 2L, only part of each of the candidate indicators 215 and 216 may be displayed. According to an embodiment, the term “predetermined angle range” may be interchangeably used with the term “user's view range.” As such, it is possible to intuitively transfer information about the external electronic device located in the user's view range, i.e., shown to the user, to the user by providing information about the external electronic device included in the predetermined angle range. According to an embodiment, the representative indicator 214 and the candidate indicators 215 and 216, along with the share sheet 223, may be displayed. Although FIG. 2L shows a plurality of candidate indicators 215 and 216, only one of the candidate indicators 215 and 216 may be displayed, or none of them may be displayed. According to an embodiment, diameter D of the representative indicator 214 may be larger than the diameter of the other indicators (e.g., the candidate indicators 215 and 216).

FIG. 2N is a view illustrating an example of determining a representative indicator 214 depending on priority according to an embodiment. Referring to FIG. 2N, according to an embodiment, although the first external electronic device 214a is positioned closer to the electronic device 101 than the other external electronic devices (e.g., the second external electronic device 215a, the third external electronic device 216a, the fourth external electronic device 217a, and the fifth external electronic device 218a), the electronic device 101 may have a history of having a highest number of shared data objects with the second external electronic device 215a among all the candidate devices. In this case, according to an embodiment, the second external electronic device 215a may be determined to be the external electronic device corresponding to the representative indicator 214. According to an embodiment, the electronic device 101 may display information (e.g., profile photo) about the second external electronic device 215a as the representative indicator 214. An image or video captured by the camera may be displayed as the representative indicator 214. According to an embodiment, a nickname (e.g., “Jasmin's phone”) of the second external electronic device 215a may be displayed around the representative indicator 214, as shown in FIG. 2N.

FIGS. 2O and 2P are views illustrating various examples of displaying the representative indicator 214 and candidate indicators 215 and 216. Referring to FIG. 2O, the representative indicator 214 and the candidate indicators 215 and 216 may be displayed via the execution screens of a separate application (e.g., a “Quick share” application). According to an embodiment, the execution screen of the application may display the representative indicator 214 and/or candidate indicators 215 and 216, indicators (e.g., the second indicator 245a, the third indicator 245b, the fourth indicator 245c, the fifth indicator 245d, and the sixth indicator 245e) individually corresponding to the external electronic devices (e.g., the first external electronic device 214a, the second external electronic device 215a, the third external electronic device 216a, the fourth external electronic device 217a, and the fifth external electronic device 218a) located within a predetermined range (e.g., within a radius of 6 m from the electronic device 101), and information 255 about at least one object to be transmitted. According to an embodiment, the indicators (e.g., the second indicator 245a, the third indicator 245b, the fourth indicator 245c, the fifth indicator 245d, and the sixth indicator 245e) may be displayed on a second region of the execution screen of the application. Referring to FIG. 2P, according to an embodiment, the representative indicator 214 and the candidate indicators 215 and 216 may be displayed in the share sheet 223.

FIGS. 2Q to 2S are views illustrating the function or operation of providing information about external electronic devices (e.g., the fourth external electronic device 217a and the fifth external electronic device 218a) located out of the predetermined angle range according to an embodiment. Referring to FIG. 2Q, according to an embodiment, the electronic device 101 may provide information about the external electronic devices (e.g., the fourth external electronic device 217a and the fifth external electronic device 218a) located out of the predetermined angle range, as well as the external electronic device(e.g., the first external electronic device 214a, the second external electronic device 215a, and the third external electronic device 216a) located within the predetermined angle range, in the form of a mini-map 265. According to an embodiment, in the mini-map, the indicators corresponding to the external electronic devices (e.g., the first external electronic device 214a, the second external electronic device 215a, and the third external electronic device 216a) located within the predetermined angle range may be visually distinguished (e.g., display in color). According to an embodiment, at least one indicator (e.g., the seventh indicator 265a, the eighth indicator 265b, the ninth indicator 265c, the tenth indicator 265d, and the eleventh indicator 265e) corresponding to the external electronic devices located around the electronic device 101 may be displayed on the mini-map 265. According to an embodiment, the share sheet 223, along with the mini-map 265, may be displayed.

Referring to FIG. 2R, according to an embodiment, the electronic device 101 may provide information about the external electronic devices (e.g., the fourth external electronic device 217a and the fifth external electronic device 218a) located out of the predetermined angle range using indicators with directivity (e.g., the twelfth indicator 217 and the thirteenth indicator 218). According to an embodiment, the indicators with directivity (e.g., the twelfth indicator 217 and the thirteenth indicator 218) may include, e.g., arrows. According to an embodiment, an icon indicating the type of the external electronic device (e.g., a tablet PC-shaped icon) may be displayed along with the indicators with directivity (e.g., the twelfth indicator 217 and the thirteenth indicator 218). According to an embodiment, the user may intuitively determine the direction of the external electronic devices (e.g., the fourth external electronic device 217a and the fifth external electronic device 218a) located out of the user's view range via the indicators with directivity (e.g., the twelfth indicator 217 and the thirteenth indicator 218). Referring to FIG. 2S, according to an embodiment, the electronic device 101 may display a notification message (e.g., “May be behind you”) indicating that the external electronic device is located out of the predetermined angle range. According to an embodiment, indicators (e.g., the fourteenth indicator 275a and the fifteenth indicator 275b) indicating the external electronic devices (e.g., the fourth external electronic device 217a and the fifth external electronic device 218a) may be displayed along with the notification message. According to an embodiment, upon receiving a selection input for the indicator (e.g., the fourteenth indicator 275a or the fifteenth indicator 275b), the electronic device 101 may transmit at least one object to the external electronic device corresponding to the selected indicator.

FIGS. 2T and 2U are views illustrating the function or operation of transmitting an object to a selected indicator when a selection input for an indicator is received, according to an embodiment. Referring to FIG. 2T, according to an embodiment, the electronic device 101 may receive a selection input on the representative indicator 214 and/or at least one candidate indicator from the user 201. Referring to FIG. 2T, according to an embodiment, the electronic device 101 may transmit at least one object to the electronic device corresponding to the representative indicator 214 and/or at least one candidate indicator. In this case, according to an embodiment, the share sheet 223 may not be displayed or, as shown in FIG. 2U, the image corresponding to at least one object to be shared may be displayed on the electronic device 101. According to an embodiment, while transmitting at least one object, the indicator with directivity (e.g., the twelfth indicator 217 and/or thirteenth indicator 218) may be displayed.

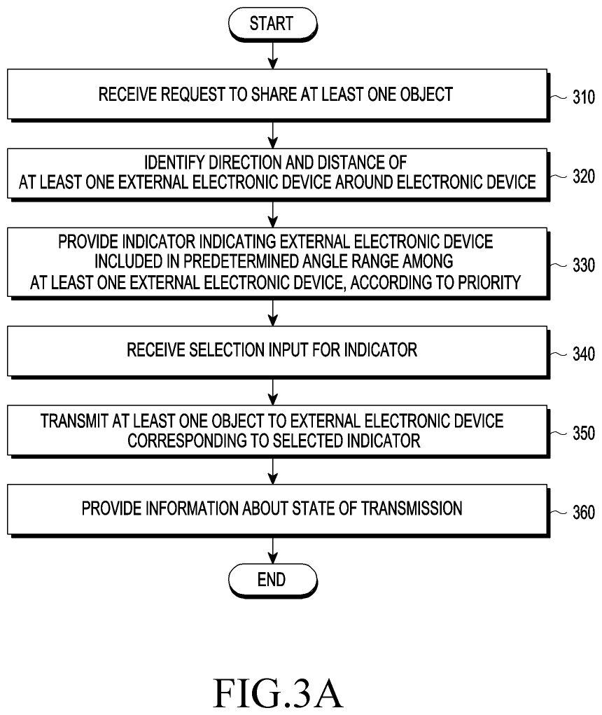

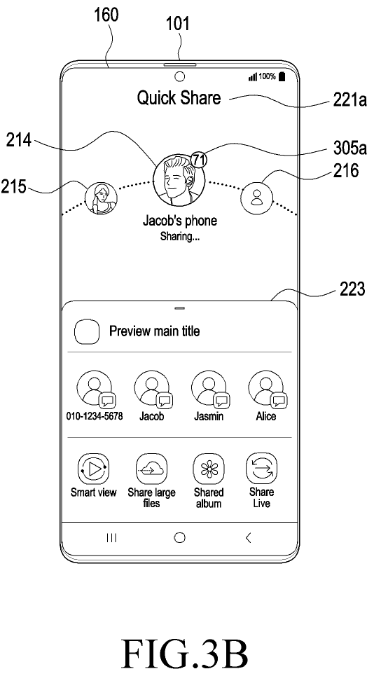

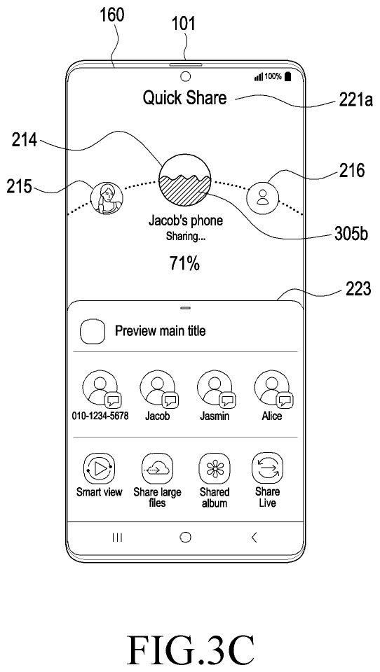

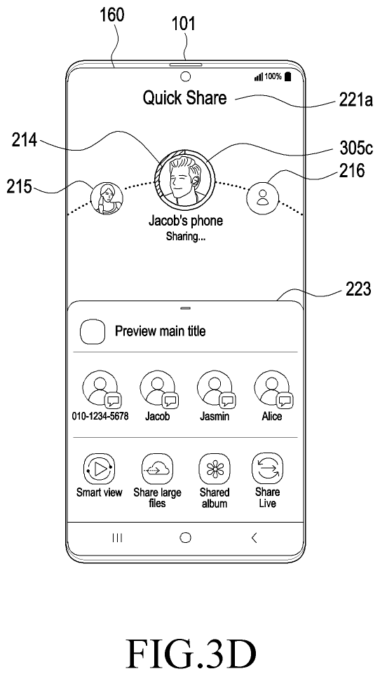

FIGS. 3A, 3B, 3C, and 3D are views illustrating the function or operation of providing information about a transmission state when an electronic device transmits an object to an external electronic device according to an embodiment.

Referring to FIG. 3A, according to an embodiment, an electronic device (e.g., the electronic device 101 of FIG. 1) may receive a request to share at least one object in operation 310. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device disposed within a communicable distance of the electronic device (e.g., the electronic device 101 of FIG. 1) in operation 320. According to an embodiment, the electronic device (e.g., the electronic device 101 of FIG. 1) may identify the direction of the external electronic device by identifying an angle of a directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device. According to an embodiment, the external electronic device may be an electronic device supporting a predetermined communication scheme (e.g., short-range communication) and may mean an electronic device capable of transmitting at least one object.

According to an embodiment, the electronic device (e.g., the electronic device 101 of FIG. 1) may display an indicator representing an external electronic device as disposed within a predetermined angle range among the at least one external electronic device, in operation 330. According to an embodiment, the electronic device (e.g., the electronic device 101 of FIG. 1) may provide (e.g., display) an indicator corresponding to an external electronic device included in a predetermined angle (e.g., 120 degrees, i.e., 60 degrees to the left and 60 degrees to the right) from the front surface of the electronic device (e.g., the electronic device 101 of FIG. 1) (e.g., the direction in which the electronic device 101 faces the external electronic device).

According to an embodiment, the electronic device (e.g., the electronic device 101 of FIG. 1) may detect a selection of the indicator in operation 340. According to an embodiment, the electronic device (e.g., the electronic device 101 of FIG. 1) may receive a selection input for the indicator by receiving a user gesture (e.g., a touch gesture) on the indicator.

According to an embodiment, the electronic device (e.g., the electronic device 101 of FIG. 1) may transmit at least one data object to the external electronic device indicated by the selected indicator in operation 350. According to an embodiment, the at least one object may be transmitted to the external electronic device via, e.g., short-range communication. According to an embodiment, the short-range communication may include various communication schemes, such as ultrawide band (UWB) communication, Bluetooth, or Wi-Fi direct. According to an embodiment, the electronic device may transmit at least one object to a predetermined external electronic device via the configured session in operation 320.

According to an embodiment, the electronic device (e.g., the electronic device 101 of FIG. 1) may provide information about the state of transmission in operation 360. According to an embodiment, the electronic device (e.g., the electronic device 101 of FIG. 1) may provide the information about the state of transmission via at least one of a badge, a user interface shaped to fill the inside of the representative indicator 214, or a user interface shaped as a circle surrounding the representative indicator 214.

Referring to FIG. 3B, according to an embodiment, the electronic device 101 may display the representative indicator 214 and at least one candidate indicator (e.g., the first candidate indicator 215 and the second candidate indicator 216). According to an embodiment, the electronic device 101 may display a badge 305a, which displays the state of transmission (e.g., transmission completion rate) in number. FIG. 3B illustrates an example in which the transmission completion rate of at least one object is 71%, including a status icon 305a indicating the progress of the transmission. According to an embodiment, the electronic device 101 may display the share sheet 223 while transmitting at least one object. Referring to FIG. 3C, according to an embodiment, the electronic device 101 may display a user interface 305b shaped to fill the inside of the representative indicator 214 representing the transmission completion rate of at least one data object being transmitted/uploaded. According to an embodiment, when the transmission completion rate of at least one object is 71%, the electronic device 101 may apply a visual effect to 71% of the inside of the representative indicator 214 to be distinguished from the rest of the representative indicator 214. Referring to FIG. 3D, according to an embodiment, the electronic device 101 may display a user interface 305c shaped as a circle surrounding the representative indicator 214 depending on the transmission completion rate of at least one object to be shared. Thus, the user may intuitively determine the transmission completion rate of at least one object to be shared.

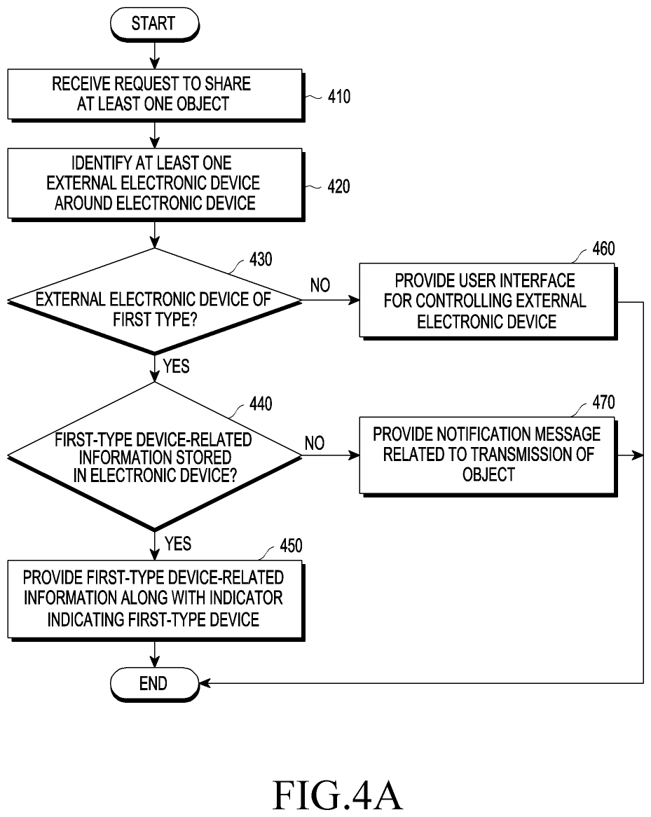

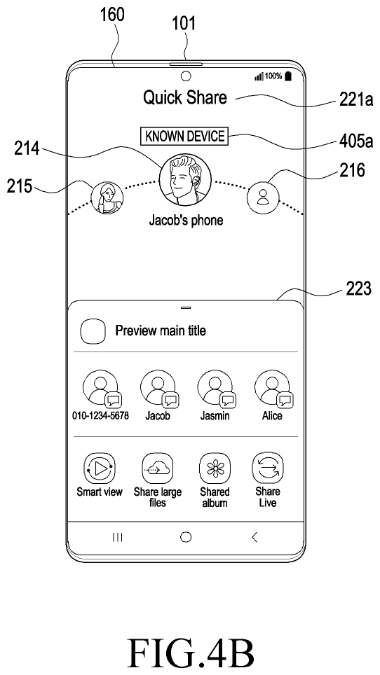

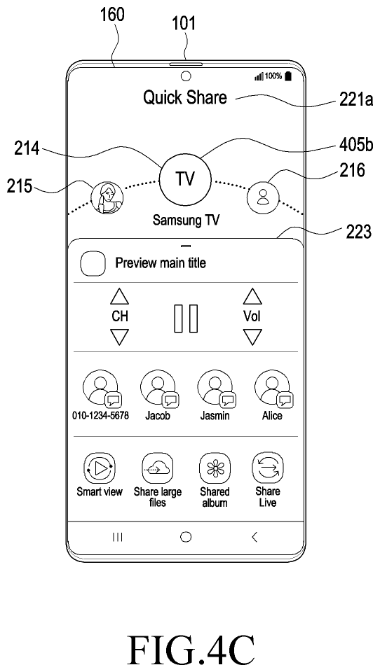

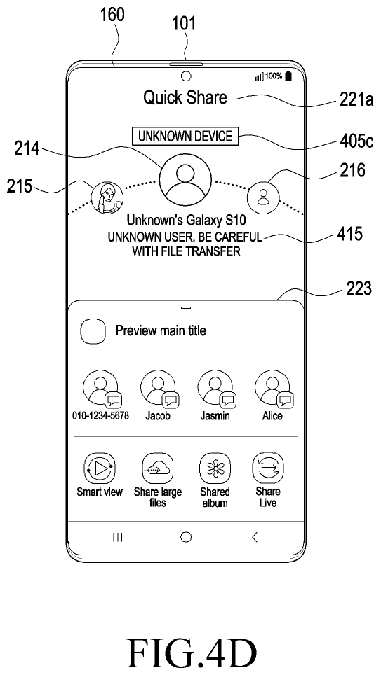

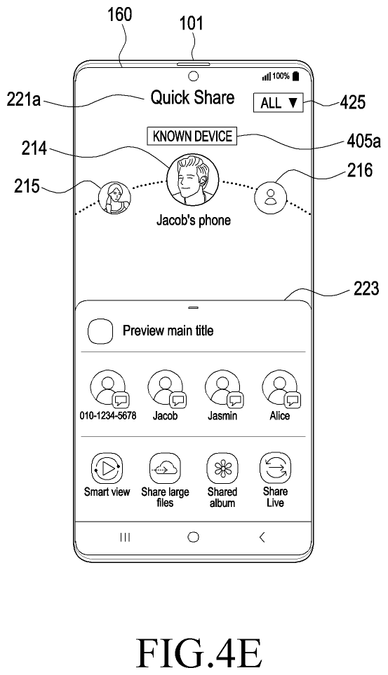

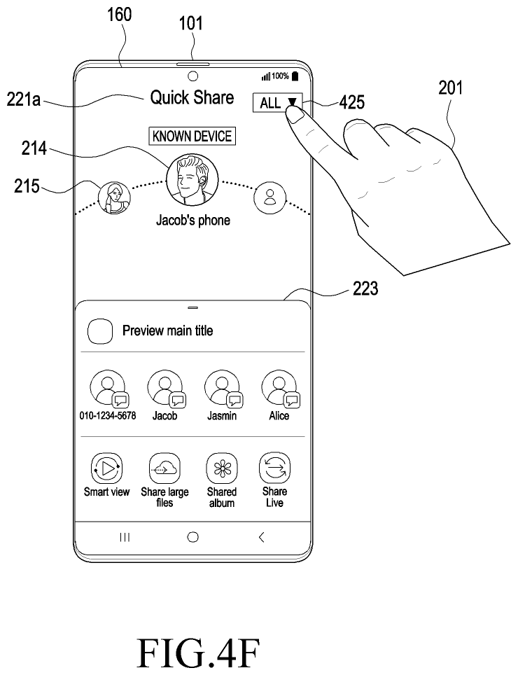

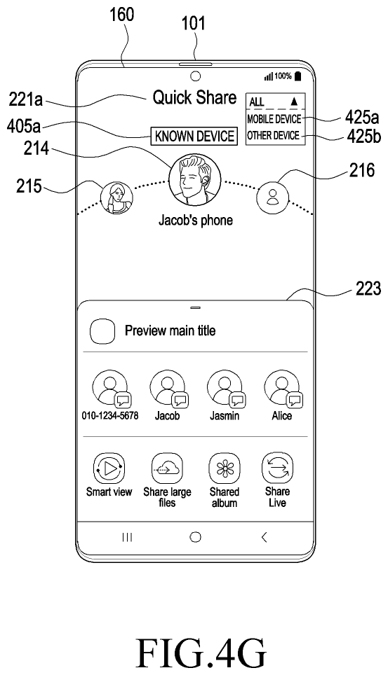

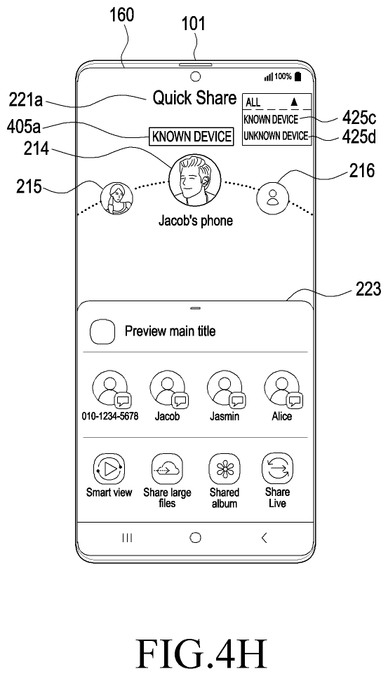

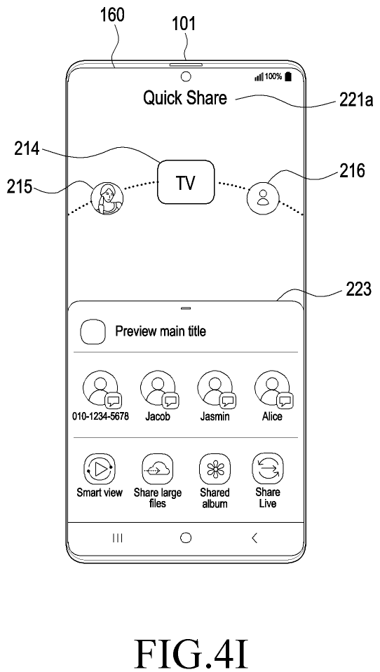

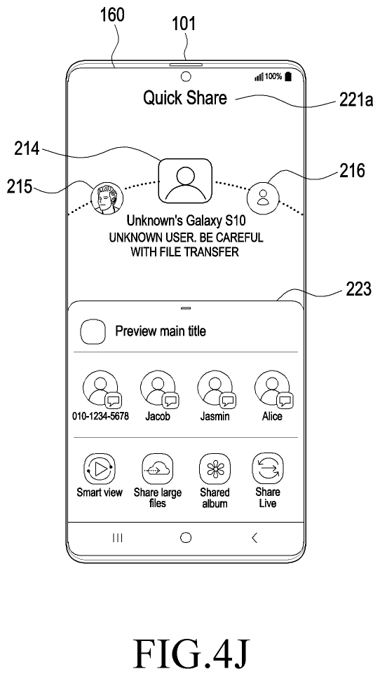

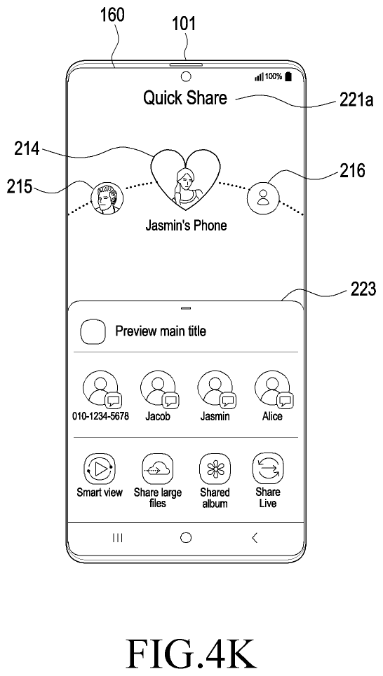

FIGS. 4A, 4B, 4C, 4D, 4E, 4F, 4G, 4H, 4I, 4J, and 4K are views illustrating the function or operation of providing different user interfaces depending on the type of an external electronic device according to an embodiment.

Referring to FIG. 4A, according to an embodiment, an electronic device (e.g., the electronic device 101 of FIG. 1) may receive a request to share at least one object in operation 410. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device around the electronic device (e.g., the electronic device 101 of FIG. 1) in operation 420. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, the electronic device (e.g., the electronic device 101 of FIG. 1) may identify whether the external electronic device is a first-type device in operation 430. That is, devices may be classified into a plurality of predefined types. For example, according to an embodiment, the first-type device may include, e.g., a portable device (e.g., a smartphone or cellular communication-enabled tablet). According to an embodiment, the electronic device (e.g., the electronic device 101 of FIG. 1) may identify whether the external electronic device is the first-type device based on information contained in a radio message received from the external electronic device. According to an embodiment, when the external electronic device is the first-type device (yes in operation 430), the electronic device (e.g., the electronic device 101 of FIG. 1) may identify whether information related to the first-type device is stored in the electronic device in operation 440. According to an embodiment, the information related to the first-type device may include at least one of the phone number of the external electronic device, which is the first-type device, a nickname of the external electronic device, and a profile photo for the external electronic device. According to an embodiment, when the information related to the first-type device is stored in the electronic device (yes in operation 440), the electronic device (e.g., the electronic device 101 of FIG. 1) may provide the information (e.g., the nickname of the external electronic device) related to the first-type device, along with an indicator (e.g., the representative indicator 214) indicating the first-type device, in operation 450.

According to an embodiment, when the external electronic device is not the first-type (NO in operation 430) (e.g., when the external electronic device is a TV which is not portable), the electronic device (e.g., the electronic device 101 of FIG. 1) in operation 460 may provide a user interface (e.g., for changing the channel) for controlling the external electronic device. According to an embodiment, there may be further provided a user interface (e.g., “Change the channel using the channel button”) for testing whether the user interface (e.g., the user interface for changing the channel) for controlling the external electronic device is properly operated. According to an embodiment, an infrared sensor may be further included to control the external electronic device. According to an embodiment, unless the information related to the first-type device is stored in the electronic device (e.g., the electronic device 101 of FIG. 1) (no in operation 440), then in operation 470 the electronic device (e.g., the electronic device 101 of FIG. 1) may provide an object transmission-related notification message (e.g., “Unknown user. Be careful with file transfer.”).

FIG. 4B is a view illustrating a screen provided when an external electronic device is a portable or mobile electronic device, and information related to the external electronic device (e.g., the first external electronic device 214a) is stored in the electronic device 101, according to an embodiment. Referring to FIG. 4B, according to an embodiment, the electronic device 101 may display a representative indicator 214 corresponding to the external electronic device (e.g., the first external electronic device 214a). According to an embodiment, when the external electronic device (e.g., the first external electronic device 214a) is the first-type device, and the information related to the external electronic device (e.g., the first external electronic device 214a) is stored in the electronic device 101, the electronic device 101 may display information (e.g., nickname “Jacob”) stored in the electronic device 101. According to an embodiment, when the external electronic device (e.g., the first external electronic device 214a) is the first-type device, and the information related to the external electronic device (e.g., the first external electronic device 214a) is stored in the electronic device 101, the electronic device 101 may display a message (e.g., “Known device”) 405a indicating that the external electronic device (e.g., the first external electronic device 214a) is a device known to the electronic device 101. By the operation, the user may intuitively recognize that the other party's electronic device is an acquaintance's electronic device.

FIG. 4C is a view illustrating the function or operation of providing a user interface for controlling an external electronic device (e.g., the first external electronic device 214a) when the external electronic device (e.g., the first external electronic device 214a) is an electronic device which is not portable or mobile, according to an embodiment. According to an embodiment, when the external electronic device is a non-portable, or non-mobile, device (e.g., TV), the electronic device 101 may display the device type 405b of the external electronic device on the representative indicator 214. According to an embodiment, the electronic device 101 may display a user interface (e.g., a channel turn interface, screen pause interface, or volume control interface) for controlling the external electronic device (e.g., the first external electronic device 214a) on a portion (e.g., the share sheet 223) of the screen.

FIG. 4D is a view illustrating the function or operation performed when the external electronic device (e.g., the first external electronic device 214a) is the first-type device but the information related to the external electronic device is not stored in the electronic device 101, according to an embodiment. Referring to FIG. 4D, according to an embodiment, when the external electronic device (e.g., the first external electronic device 214a) is the first-type device but the information related to the external electronic device is not stored in the electronic device 101, the electronic device 101 may provide a notification message 415 (e.g., “Unknown user. Be careful with file transfer”) related to the transmission of an object. According to an embodiment, the electronic device 101 may display a message 405c (e.g., “Unknown device”) indicating that the external electronic device (e.g., the first external electronic device 214a) is a device unknown to the electronic device 101.

FIGS. 4E, 4F, 4G, and 4H are views illustrating the function or operation of displaying only a predetermined type of electronic device via a filter. Referring to FIG. 4E, according to an embodiment, the electronic device 101 may display a filter 425. FIG. 4E illustrates an example in which information about all types of external electronic devices is displayed regardless of the type of the external electronic device. Referring to FIG. 4F, according to an embodiment, the electronic device 101 may receive a user input for the filter 425. Referring to FIG. 4G, according to an embodiment, upon receiving the user input for the filter 425, the electronic device 101 may display a menu item 425a for receiving a selection of whether to display only mobile devices and a menu item 425b for receiving a selection of whether to display the other devices than mobile devices. Referring to FIG. 4H, the electronic device 101 may display a menu item 425c for receiving a selection of whether to display only devices known to the electronic device 101 (e.g., when the phone number of the external electronic device is stored in the electronic device 101) and a menu item 425d for receiving a selection of whether to display only devices unknown to the electronic device 101 (e.g., when the phone number of the external electronic device is not stored in the electronic device 101). According to an embodiment, upon receiving a selection input for each menu item, e.g., upon receiving a user input to display only devices known to the electronic device 101, the electronic device 101 may display only devices known to the electronic device 101.

FIGS. 4I, 4J, and 4K are views illustrating the function or operation of providing indicators in different shapes depending on the type of the external electronic device (e.g., the first external electronic device 214a). Referring to FIG. 4I, according to an embodiment, when the external electronic device (e.g., the first external electronic device 214a) does not support cellular communication and is a non-portable device (e.g., TV), the electronic device 101 may display the same with an indicator shaped (e.g., a rectangle with rounded corners) to be distinguished from cellular communication-enabled, portable devices (e.g., smartphones). As another example, referring to FIG. 4J, according to an embodiment, when the external electronic device (e.g., the first external electronic device 214a) is a device unknown to the electronic device 101 (e.g., when the phone number of the external electronic device is not stored in the electronic device 101), the electronic device 101 may display the same with an indicator shaped (e.g., a rectangle with rounded corners) to be distinguished from the known devices. As another example, referring to FIG. 4K, according to an embodiment, when the external electronic device is an external electronic device frequently sharing objects (e.g., when it shares objects a predetermined number of times or more), the electronic device 101 may display the same with an indicator shaped to be distinguished from the external electronic devices infrequently sharing objects (e.g., a heart shape, a color different from those of the external electronic devices infrequently sharing objects, and/or a size different from those of the external electronic devices infrequently sharing objects).

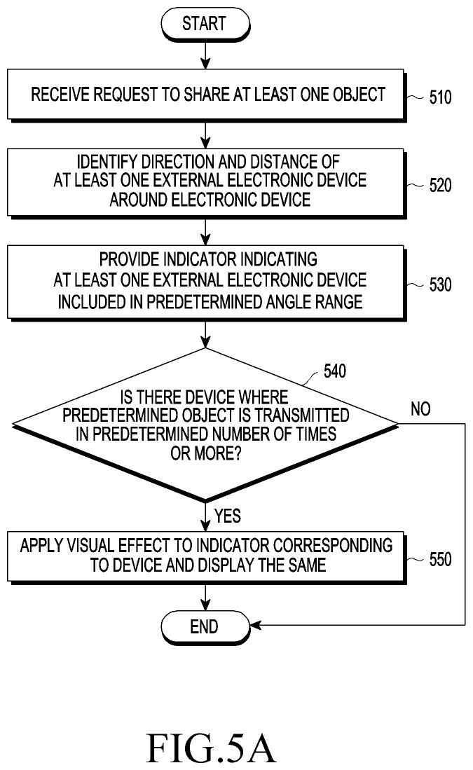

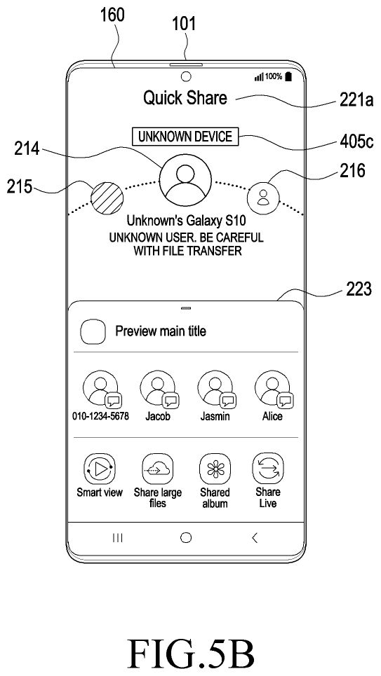

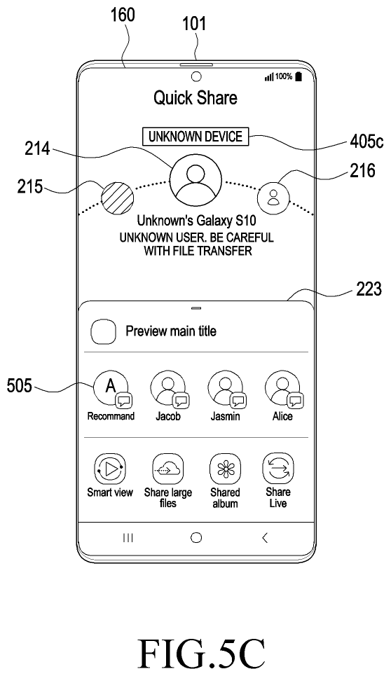

FIGS. 5A, 5B, and 5C are views illustrating the function or operation of applying a visual effect to an indicator and providing the same, depending on the number of transmissions of a predetermined object for an external electronic device according to an embodiment.

Referring to FIG. 5A, according to an embodiment, an electronic device (e.g., the electronic device 101 of FIG. 1) may receive a request to share at least one object in operation 510. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device near the electronic device (e.g., the electronic device 101 of FIG. 1) in operation 520. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, the electronic device (e.g., the electronic device 101 of FIG. 1) may provide an indicator indicating an external electronic device included in a predetermined angle range from among the at least one external electronic device, in operation 530. According to an embodiment, the electronic device (e.g., the electronic device 101 of FIG. 1) may provide (e.g., display) an indicator corresponding to an external electronic device included in a predetermined angle (e.g., 120 degrees, i.e., 60 degrees to the left and 60 degrees to the right) from the front surface of the electronic device (e.g., the electronic device 101 of FIG. 1) (e.g., the direction in which the electronic device 101 faces the external electronic device).

According to an embodiment, the electronic device (e.g., the electronic device 101 of FIG. 1) may identify whether a device exists for which a predetermined object was transmitted a predetermined number of times or more, in operation 540. According to an embodiment, the electronic device (e.g., the electronic device 101 of FIG. 1) may identify whether a predetermined object is transmitted a predetermined number of times or more by identifying the transmission history for a specific external electronic device.

According to an embodiment, when there is a device for which the predetermined object is transmitted the predetermined number of times or more (yes in operation 540), the electronic device (e.g., the electronic device 101 of FIG. 1) may apply a visual effect to the indicator corresponding to the device and display the same in operation 550.

FIGS. 5B and 5C are views illustrating the function or operation of the electronic device 101 applying a visual effect to the indicator corresponding to a device for which a predetermined object is transmitted a predetermined number of times or more and displaying the same, according to an embodiment. Referring to FIG. 5B, according to an embodiment, the electronic device 101 may identify a transmission history for a predetermined object for the identified external electronic devices (e.g., the first external electronic device 214a, the second external electronic device 215a, the third external electronic device 216a, the fourth external electronic device 217a, and the fifth external electronic device 218a). According to an embodiment, the electronic device 101 may identify whether there is a device for which a predetermined object is transmitted a predetermined number of times or more, based on the identified transmission history. According to an embodiment, when there is a device for which the predetermined object is transmitted the predetermined number of times or more, the electronic device 101 may apply a visual effect to the indicator corresponding to the device and display the same. According to an embodiment, the visual effect may include a color effect. FIG. 5B illustrates an example in which the second external electronic device 215a is the device for which the predetermined object is transmitted the predetermined number of times or more. Thus, according to an embodiment, the electronic device 101 may apply a predetermined color (e.g., yellow) to the first candidate indicator 215 and display the same. Referring to FIG. 5C, according to an embodiment, the electronic device 101 may provide the object (e.g., a predetermined image file) frequently transmitted along with the color effect, as a recommended object 505. According to an embodiment, the recommended object 505 may be displayed on the share sheet 223. According to an embodiment, upon receiving a selection input for the recommended object 505 and a selection input for a predetermined indicator (e.g., the representative indicator 214), the electronic device 101 may transmit the recommended object to the external electronic device corresponding to the selected indicator.

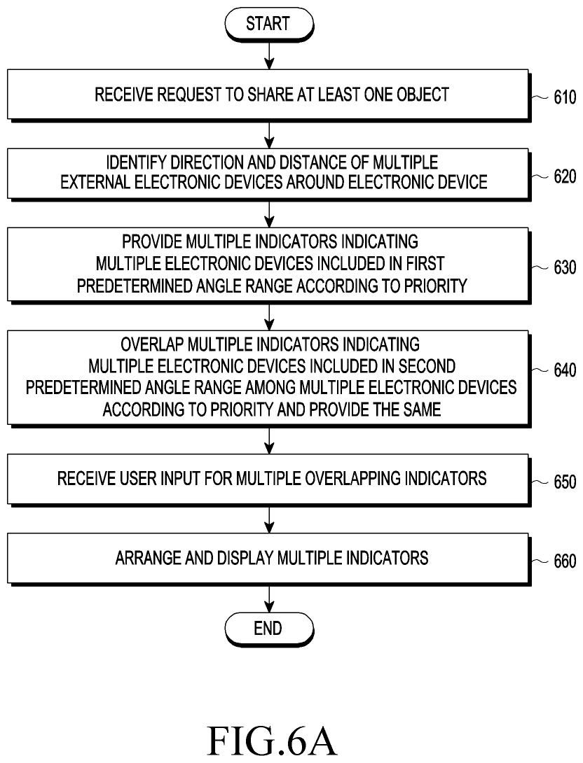

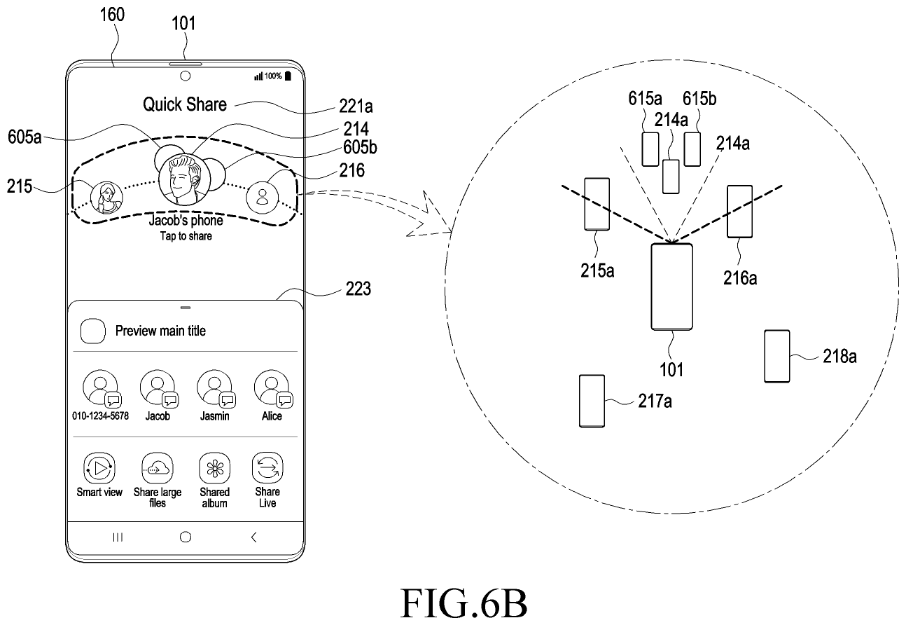

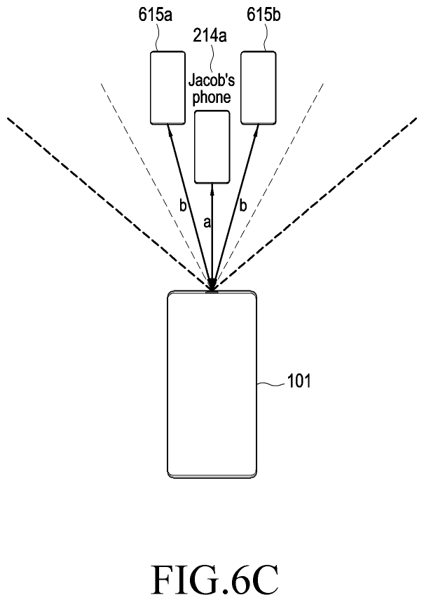

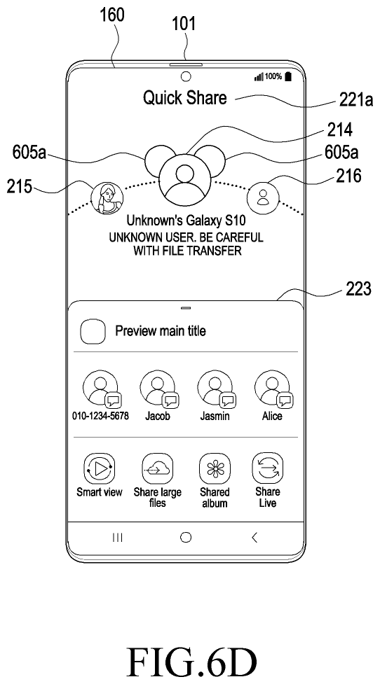

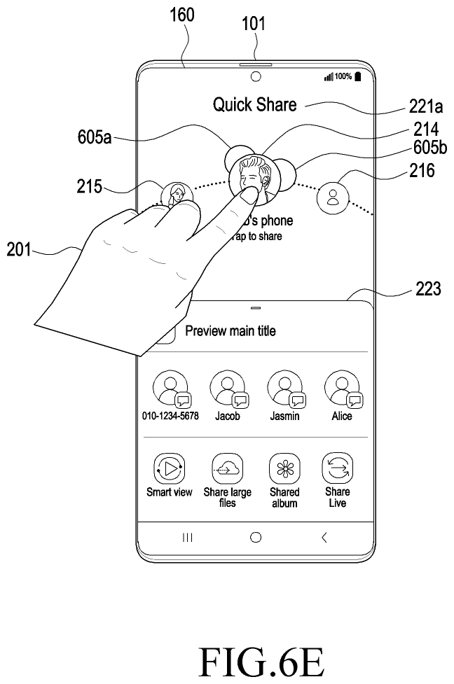

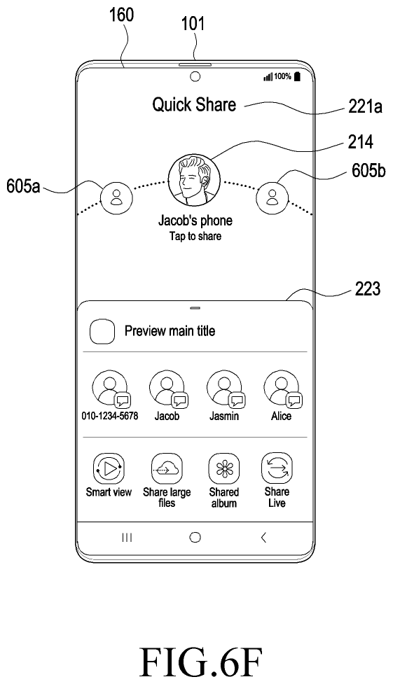

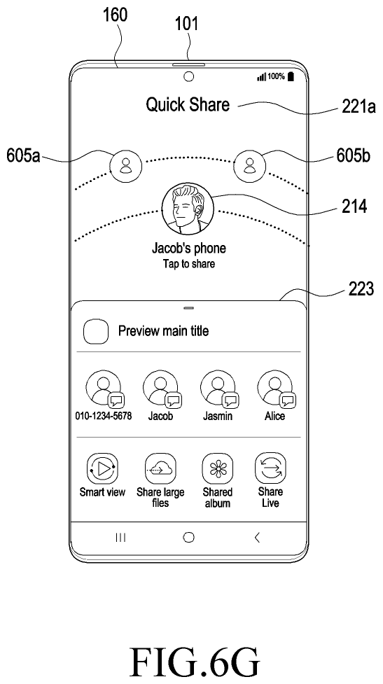

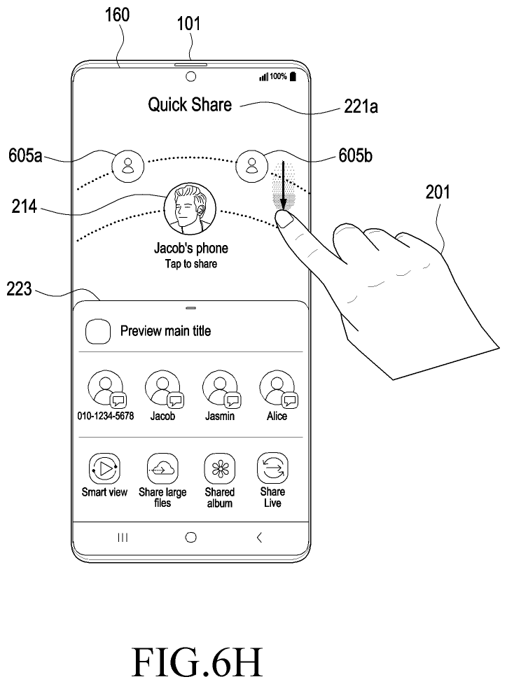

FIGS. 6A, 6B, 6C, 6D, 6E, 6F, 6G, and 6H are views illustrating the function or operation of providing an indicator when there are a plurality of electronic devices adjacent to each other, according to an embodiment.

Referring to FIG. 6A, according to an embodiment, an electronic device (e.g., the electronic device 101 of FIG. 1) may receive a request to share at least one object in operation 610. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of each of a plurality of external electronic devices around the electronic device (e.g., the electronic device 101 of FIG. 1) in operation 620. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, the electronic device (e.g., the electronic device 101 of FIG. 1) may provide (e.g., display) the external electronic device included in a predetermined angle range (e.g., 120 degrees) according to priority in operation 630. According to an embodiment, the electronic device (e.g., the electronic device 101 of FIG. 1) may provide (e.g., display) an indicator corresponding to an external electronic device included in a predetermined angle (e.g., 120 degrees, i.e., 60 degrees to the left and 60 degrees to the right) from the front surface of the electronic device (e.g., the electronic device 101 of FIG. 1) (e.g., the direction in which the electronic device 101 faces the external electronic device).

According to an embodiment, the electronic device (e.g., the electronic device 101 of FIG. 1) may allow overlap of indicators when displaying a plurality of indicators, representing at least some electronic devices among the plurality of external electronic devices according to priority, in operation 640. According to an embodiment, upon determining that the external electronic devices are positioned near one another (e.g., the difference between the angles corresponding to the directions in which the external electronic devices are located is within a predetermined angle (e.g., 5 degrees), the electronic device (e.g., the electronic device 101 of FIG. 1) may allow overlap when displaying the plurality of indicators indicating the plurality of electronic devices near one another.

According to an embodiment, the electronic device (e.g., the electronic device 101 of FIG. 1) may receive a user input for the plurality of overlapping indicators in operation 650. According to an embodiment, the electronic device (e.g., the electronic device 101 of FIG. 1) may arrange and display the plurality of indicators in operation 660 to enable more accurate user selection of a particular indicator.

FIGS. 6B, 6C, and 6D are views illustrating the function or operation of the electronic device 101 allowing, to overlap, and displaying the indicators corresponding to the plurality of external electronic devices according to an embodiment. Referring to FIG. 6B, according to an embodiment, the electronic device 101 may identify that the plurality of external electronic devices (e.g., the first external electronic device 214a, the sixth external electronic device 615a, and the seventh external electronic device 615b) are arranged near one another. According to an embodiment, when the difference between the angles corresponding to the directions in which the plurality of external electronic devices are located is within a predetermined angle difference, the electronic device may identify that they are arranged near one another. According to an embodiment, the electronic device 101 may allow to overlap and display the indicators corresponding to the plurality of external electronic devices (e.g., the first external electronic device 214a, the sixth external electronic device 615a, and the seventh external electronic device 615b) depending on priority (e.g., the distance from the electronic device 101). Referring to FIG. 6C, since the distance a between the electronic device 101 and the first external electronic device 214a is shortest, the indicator corresponding to the first external electronic device 214a may be determined to be the representative indicator 214 according to the priority. As another example, the external electronic device which has transmit the predetermined object most may have the highest priority. In this case, the indicator corresponding to an external electronic device other than the external electronic device (e.g., the first external electronic device 214a) closest to the electronic device 101 may be determined to be the representative indicator 214 as shown in FIG. 6D. As used herein, when external electronic devices are arranged near one another, this may mean that the external electronic devices are not spaced apart enough to be displayed as independent indicators.

FIGS. 6E, 6F, 6G, and 6H are views illustrating the function or operation of arranging overlapping indicators according to a user input. Referring to FIG. 6E, according to an embodiment, the electronic device 101 may receive a selection input for a plurality of overlapping indicators (e.g., the representative indicator 214, the third candidate indicator 605a, and the fourth candidate indicator 605b) displayed. Referring to FIG. 6F, according to an embodiment, the electronic device 101 may display the plurality of indicators (e.g., the representative indicator 214, the third candidate indicator 605a, and the fourth candidate indicator 605b) on the same line. Alternatively, as shown in FIG. 6G, the third candidate indicator 605a and the fourth candidate indicator 605b may be displayed on a line different from the representative indicator 214. When the third candidate indicator 605a and the fourth candidate indicator 605b are displayed on a line different from the representative indicator 214, the electronic device 101, according to an embodiment, may receive a user input of dragging down. In this case, according to an embodiment, the electronic device 101 may display the plurality of indicators (e.g., the representative indicator 214, the third candidate indicator 605a, and the fourth candidate indicator 605b) on the same line as shown in FIG. 6F.

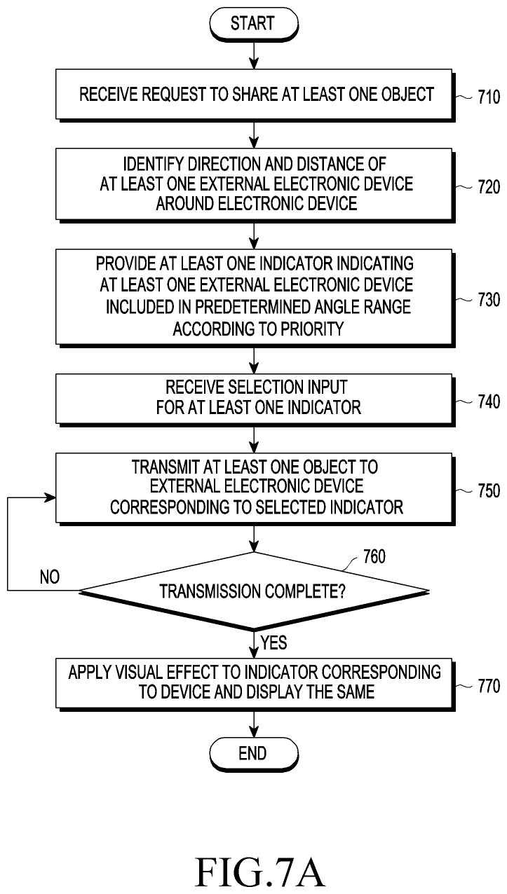

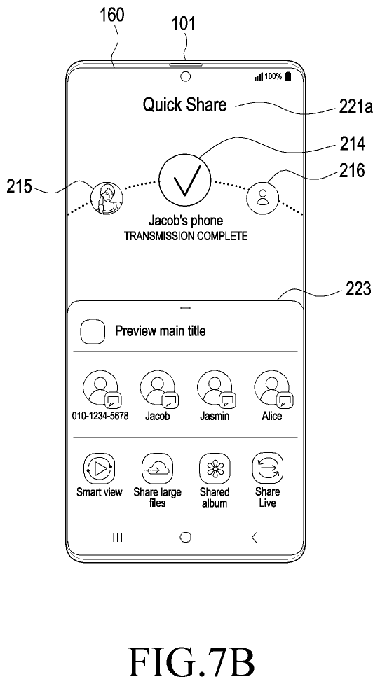

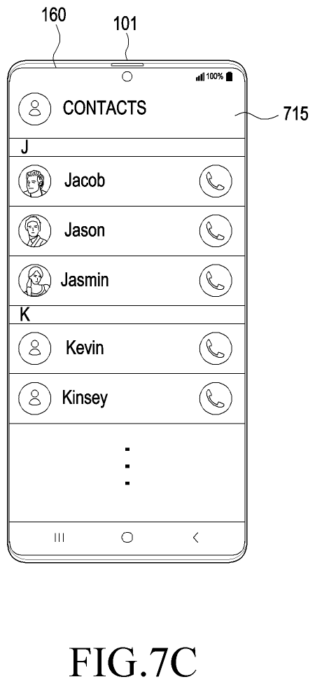

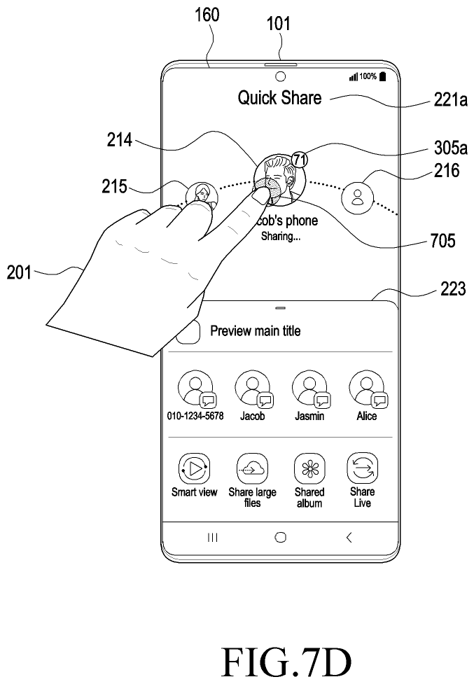

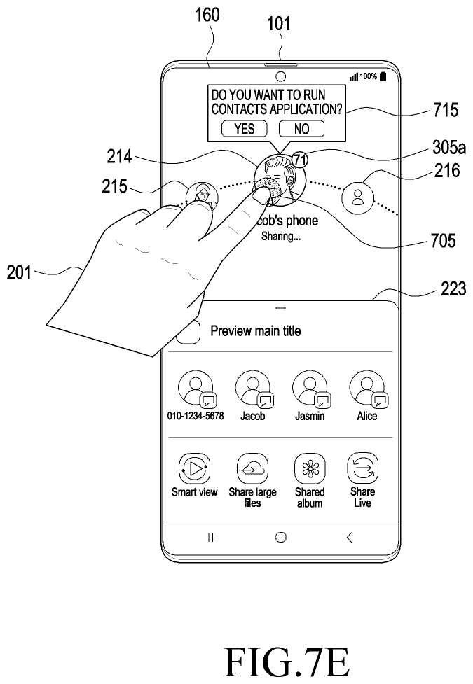

FIGS. 7A, 7B, 7C, 7D, and 7E are views illustrating the function or operation of executing a contacts application after an electronic device transmits a predetermined object to an external electronic device according to an embodiment.

Referring to FIG. 7A, according to an embodiment, an electronic device (e.g., the electronic device 101 of FIG. 1) may receive a request to share at least one object in operation 710. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device around the electronic device (e.g., the electronic device 101 of FIG. 1) in operation 720. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, the electronic device (e.g., the electronic device 101 of FIG. 1) may provide an indicator indicating an external electronic device included in a predetermined angle range among the at least one external electronic device, in operation 730. According to an embodiment, the electronic device (e.g., the electronic device 101 of FIG. 1) may provide (e.g., display) an indicator corresponding to an external electronic device included in a predetermined angle (e.g., 120 degrees, i.e., 60 degrees to the left and 60 degrees to the right) from the front surface of the electronic device (e.g., the electronic device 101 of FIG. 1) (e.g., the direction in which the electronic device 101 faces the external electronic device).

According to an embodiment, the electronic device (e.g., the electronic device 101 of FIG. 1) may receive a selection input for at least one indicator in operation 740. According to an embodiment, the electronic device (e.g., the electronic device 101 of FIG. 1) may receive a selection input for the indicator by receiving a user gesture (e.g., a touch gesture) on the indicator.

According to an embodiment, the electronic device (e.g., the electronic device 101 of FIG. 1) may transmit at least one object to the external electronic device corresponding to the selected indicator in operation 750. According to an embodiment, the at least one object may be transmitted to the external electronic device via, e.g., short-range communication. According to an embodiment, the short-range communication may include various communication schemes, such as ultrawide band (UWB) communication, Bluetooth, or Wi-Fi direct. According to an embodiment, the electronic device may transmit at least one object to a predetermined external electronic device via the configured session in operation 720.

According to an embodiment, the electronic device (e.g., the electronic device 101 of FIG. 1) may determine whether transmission of at least one object to the external electronic device corresponding to the selected indicator has been completed in operation 760. According to an embodiment, when transmission of at least one object to the external electronic device corresponding to the selected indicator has been completed (yes in operation 760), then in operation 770, the electronic device (e.g., the electronic device 101 of FIG. 1) may apply a visual effect to the indicator corresponding to the device to indicate successful completion of the transmission.

FIGS. 7B and 7C are views illustrating the function or operation of the electronic device 101 executing a contacts application after transmission of at least one object is complete, according to an embodiment. Referring to FIG. 7B, according to an embodiment, after transmission of at least one object is complete, the electronic device 101 may display an indicator indicating that transmission has been completed on the representative indicator 214. According to an embodiment, after transmission of at least one object is complete, the electronic device 101 may display the execution screen of the contacts application as shown in FIG. 7C.

FIGS. 7D and 7E are views illustrating the function or operation of the electronic device 101 executing a contacts application according to a user input while transmitting at least one object, according to an embodiment. Referring to FIG. 7D, according to an embodiment, the electronic device 101 may receive a user input 705 for the representative indicator 214 while transmitting at least one object to be shared to the external electronic device. Referring to FIG. 7E, according to an embodiment, the electronic device 101 may display a notification message 715 inquiring whether to execute the contacts application according to the reception of the user input. According to an embodiment, the electronic device 101 may receive a response (e.g., “yes”) to the notification message, inquiring whether to execute the contacts application, from the user and execute the contacts application while transmitting a predetermined object to the outside according to the response.

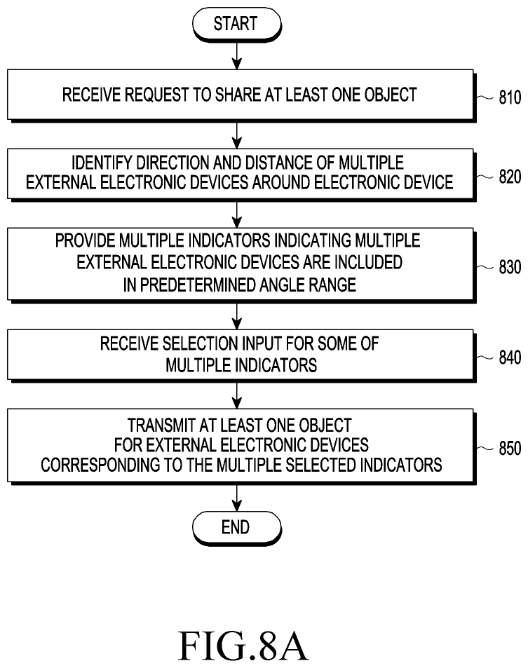

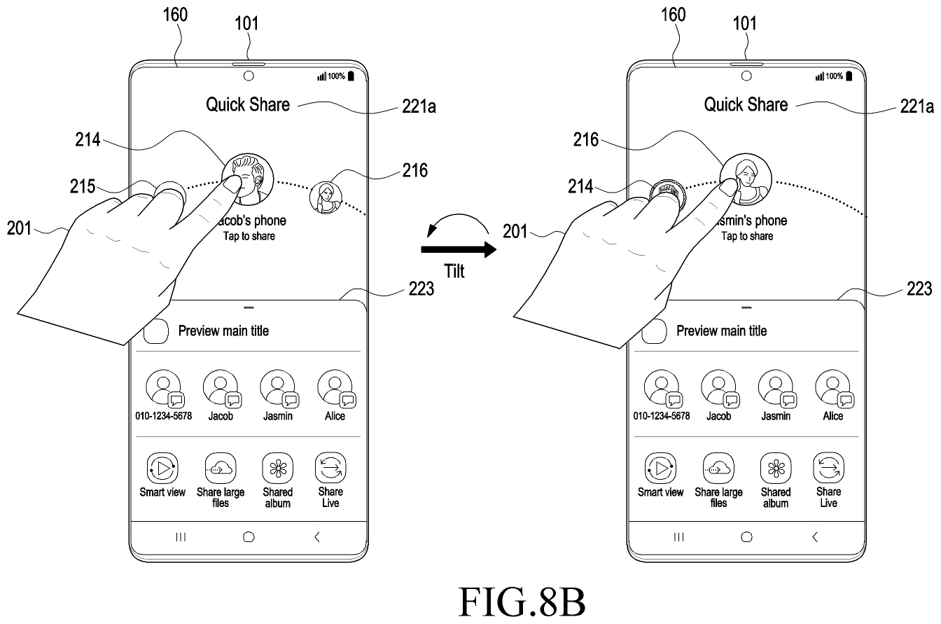

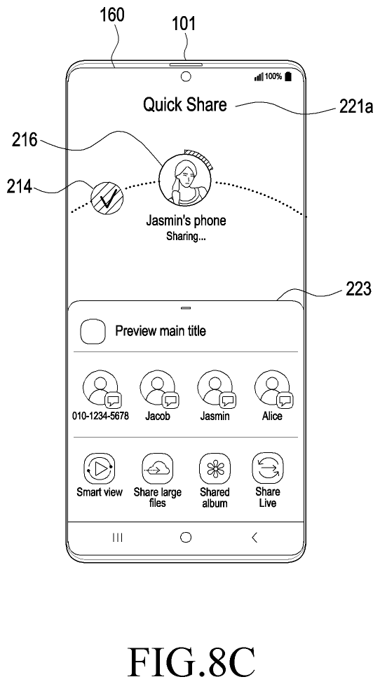

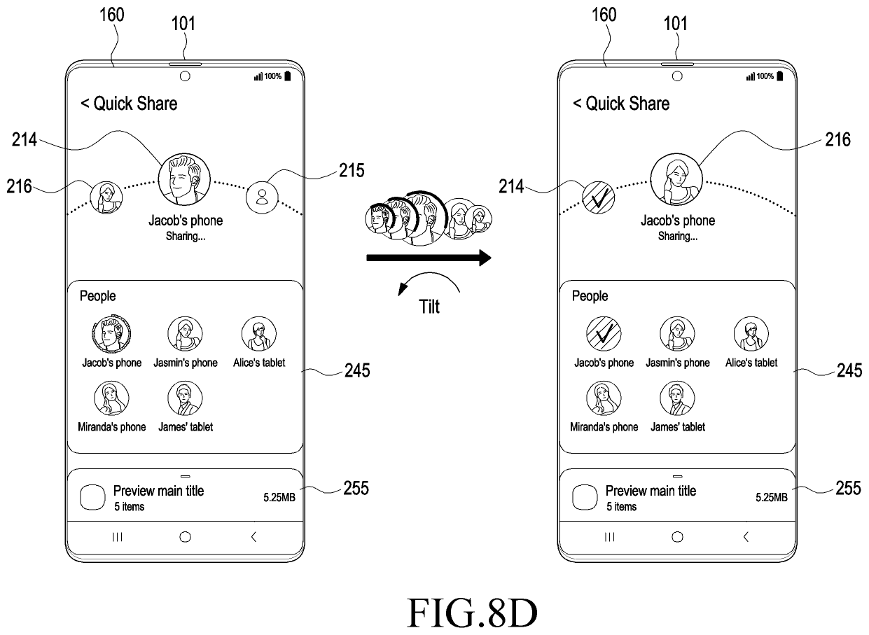

FIGS. 8A, 8B, 8C, and 8D are views illustrating the function or operation of providing at least one user interface which is provided when an electronic device transmits predetermined objects to a plurality of external electronic devices according to an embodiment.

Referring to FIG. 8A, according to an embodiment, an electronic device (e.g., the electronic device 101 of FIG. 1) may receive a request to share at least one object in operation 810. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of a plurality of external electronic devices near the electronic device (e.g., within a threshold communicable distance of, for example, the electronic device 101 of FIG. 1) in operation 820. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, the electronic device (e.g., the electronic device 101 of FIG. 1) may provide indicators indicating a plurality of external electronic devices included in a predetermined angle range, in operation 830. According to an embodiment, the electronic device (e.g., the electronic device 101 of FIG. 1) may provide (e.g., display) an indicator corresponding to an external electronic device included in a predetermined angle (e.g., 120 degrees, i.e., 60 degrees to the left and 60 degrees to the right) from the front surface of the electronic device (e.g., the electronic device 101 of FIG. 1) (e.g., the direction in which the electronic device 101 faces the external electronic device). As noted earlier, when multiple indicators are displayed for multiple devices, they may be arranged according to priority.

According to an embodiment, the electronic device (e.g., the electronic device 101 of FIG. 1) may receive a selection input for multiple of indicators in operation 840. According to an embodiment, the electronic device (e.g., the electronic device 101 of FIG. 1) may receive a selection input for multiple indicators by sequentially receiving multiple user gestures (e.g., touch inputs) on the indicators.

According to an embodiment, the electronic device (e.g., the electronic device 101 of FIG. 1) may transmit at least one object to the external electronic devices corresponding to the selected indicators in operation 850. According to an embodiment, the at least one object may be transmitted to the external electronic device via, e.g., short-range communication. According to an embodiment, the short-range communication may include various communication schemes, such as ultrawide band (UWB) communication, Bluetooth, or Wi-Fi direct. According to an embodiment, the electronic device may transmit at least one object to a predetermined external electronic device via the configured session in operation 820.

Referring to FIG. 8B, according to an embodiment, the electronic device 101 may receive a selection input for the representative indicator 214 from the user 201. According to an embodiment, upon receiving a selection input for the representative indicator 214 from the user 201, the electronic device 101 may transmit a predetermined object to the external electronic device corresponding to the representative indicator 214. In this case, according to an embodiment, the electronic device 101 may display a user interface 305c shaped as a circle surrounding the representative indicator 214 depending on the transmission completion rate of the predetermined object. According to an embodiment, after receiving the selection input for the representative indicator 214 from the user 201, the electronic device 101 may receive a user input to tilt the electronic device 101 to the left. In this case, according to an embodiment, the electronic device 101 may move the second candidate indicator 216 to where the representative indicator 214 is positioned. According to an embodiment, the electronic device 101 may receive a selection input for the second candidate indicator 216. According to an embodiment, the electronic device 101 may transmit the predetermined object to the external electronic device corresponding to the second candidate indicator 216 while simultaneously transmitting the predetermined object to the external electronic device corresponding to the representative indicator 214. In this case, as shown in FIG. 8C, a user interface shaped as a circle surrounding the representative indicator 214 may be displayed depending on the transmission completion rate of the predetermined object to the surroundings of the second candidate indicator 216. Referring to FIG. 8D, when a predetermined sharing scheme is executed via a predetermined application, the functions or operations shown in FIG. 8B or 8C may be performed likewise on the execution screen of the application. According to an embodiment, the electronic device 101 may receive a selection input for the representative indicator 214 and a selection input for the indicator displayed on the second region 245 of the execution screen of the application. Therefore, according to an embodiment, the electronic device 101 may share the predetermined object with a plurality of external electronic devices.

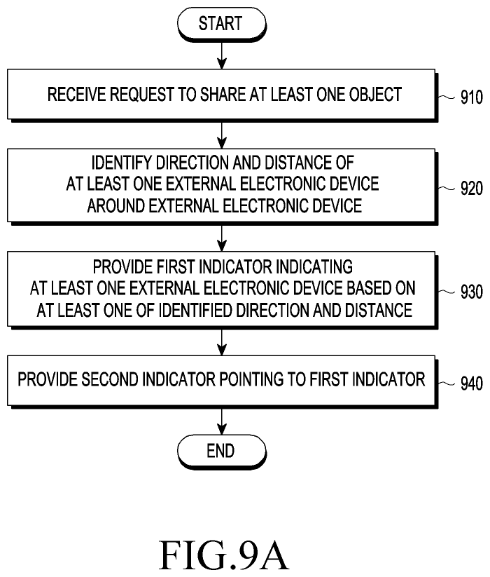

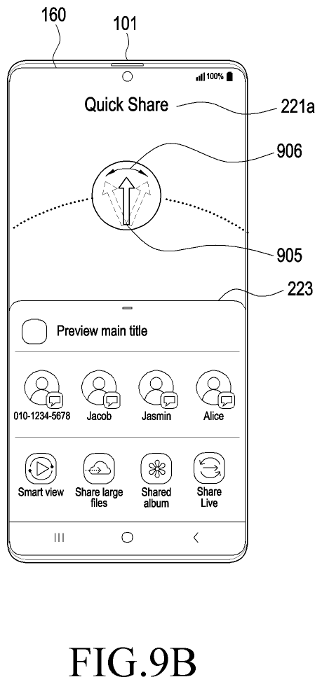

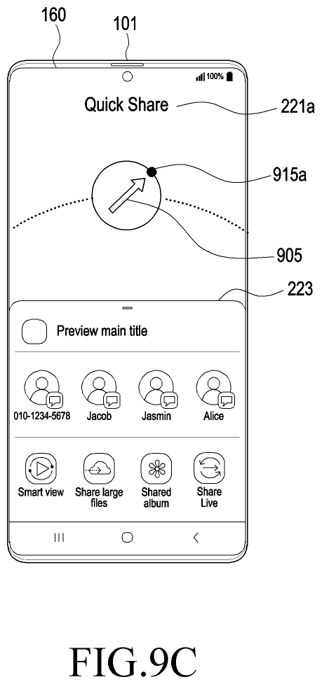

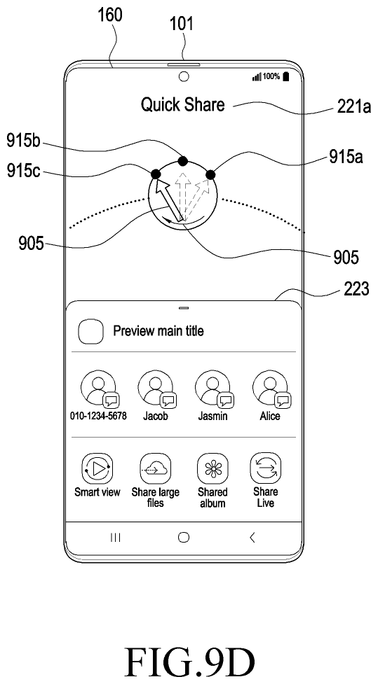

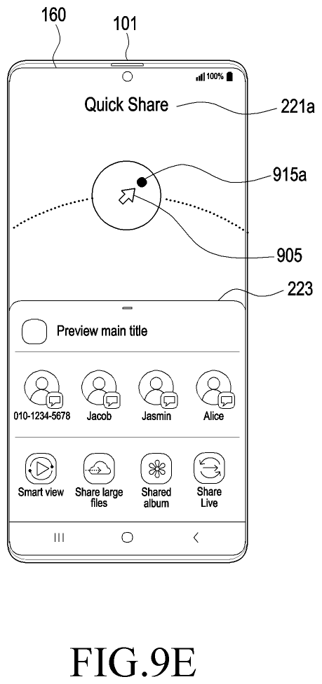

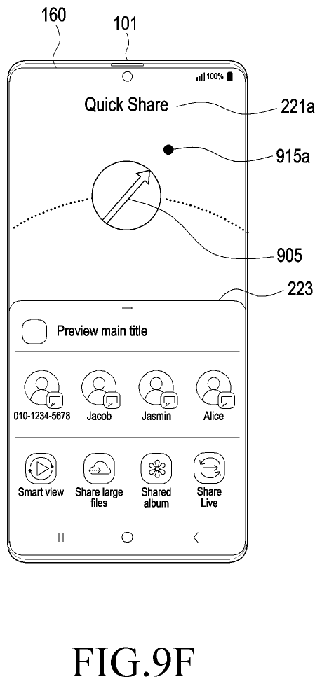

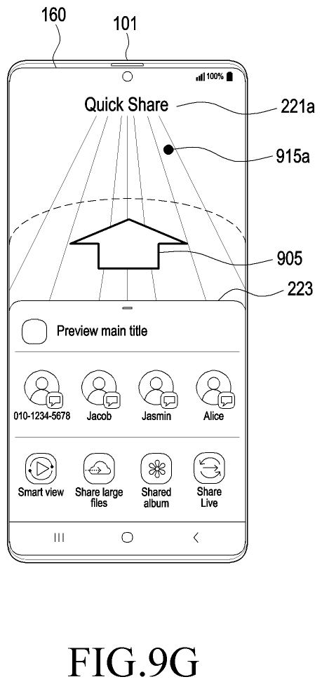

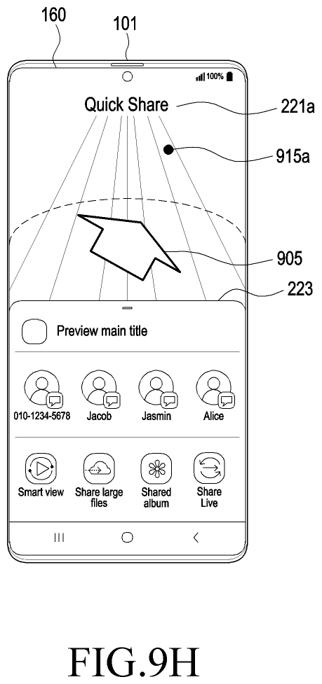

FIGS. 9A, 9B, 9C, 9D, 9E, 9F, 9G, and 9H are views illustrating the function or operation of an electronic device providing information about the location and direction of an external electronic device using a plurality of indicators according to an embodiment.

Referring to FIG. 9A, according to an embodiment, an electronic device (e.g., the electronic device 101 of FIG. 1) may receive a request to share at least one object in operation 910. According to an embodiment, the at least one object may include various formats of files, such as image files, text files, or video files. According to an embodiment, the electronic device (e.g., the electronic device 101 of FIG. 1) may receive the request to share at least one object by receiving a user's gesture (e.g., a long-touch gesture) on a specific object.

According to an embodiment, the electronic device (e.g., the electronic device 101 of FIG. 1) may identify the direction and/or distance of at least one external electronic device around the electronic device (e.g., the electronic device 101 of FIG. 1) in operation 920. According to an embodiment, the electronic device (e.g., the electronic device 101 of FIG. 1) may identify the direction of the external electronic device by identifying the angle of the directional beam output from the electronic device (e.g., the electronic device 101 of FIG. 1). According to an embodiment, the electronic device (e.g., the electronic device 101 of FIG. 1) may identify the distance from at least one external electronic device using the transmission/reception time of the radio message transmitted/received with the external electronic device. According to an embodiment, a session for transmission/reception of radio messages may be configured between the electronic device (e.g., the electronic device 101 of FIG. 1) and the external electronic device.

According to an embodiment, in operation 930, the electronic device (e.g., the electronic device 101 of FIG. 1) may provide a first indicator (e.g., the sixteenth indicator 915a of FIG. 9C) indicating at least one external electronic device, based on at least one of the identified direction and distance. According to an embodiment, in operation 940, the electronic device (e.g., the electronic device 101 of FIG. 1) may provide a second indicator (e.g., the seventh indicator 905 of FIG. 9B) pointing to the first indicator. According to an embodiment, the second indicator may include an indicator with directivity, e.g., an arrow. According to an embodiment, the first indicator (e.g., the sixteenth indicator 915a of FIG. 9C) may not be provided while the second indicator (e.g., the seventeenth indicator 905 of FIG. 9B) alone is provided. According to an embodiment, the first indicator (e.g., the sixteenth indicator 915a of FIG. 9C) may be changed in shape depending on the direction and/or distance of the external electronic device. For example, according to an embodiment, when the first indicator (e.g., the sixteenth indicator 915a of FIG. 9C) is able to indicate the direction of the identified external electronic device or the distance from the external electronic device is short, its length may be reduced than its preset length.

Referring to FIG. 9B, according to an embodiment, the electronic device 101 may provide the seventeenth indicator 905 while searching for at least one external electronic device. According to an embodiment, the electronic device 101 may continuously move (906) and display the seventeenth indicator 905 while searching for at least one external electronic device. Referring to FIG. 9C, according to an embodiment, when the search for an external electronic device is complete, the electronic device 101 may display the sixteenth indicator 915a indicating at least one external electronic device. According to an embodiment, when the search for an external electronic device is complete, the electronic device 101 may display information related to the discovered external electronic device (e.g., the phone number of the external electronic device, the profile photo of the external electronic device, and/or the nickname of the external electronic device) in at least a portion of the display device 160.

According to an embodiment, the share sheet 223 may be displayed while the sixteenth indicator 915a and the seventeenth indicator 905 are displayed. Referring to FIG. 9D, when a plurality of external electronic devices are discovered, a plurality of indicators (e.g., the sixteenth indicator 915c, the eighteenth indicator 915b, and the nineteenth indicator 915c) may be displayed. According to an embodiment, the electronic device 101 may control the seventeenth indicator 905 to sequentially indicate the plurality of indicators (e.g., the sixteenth indicator 915c, the eighteenth indicator 915b, and the nineteenth indicator 915c). For example, the seventeenth indicator 905 may sequentially indicate the plurality of indicators (e.g., the sixteenth indicator 915c, the eighteenth indicator 915b, and the nineteenth indicator 915c) while rotating left. According to an embodiment, the seventeenth indicator 905 may be temporarily stopped while indicating the plurality of indicators (e.g., the sixteenth indicator 915c, the eighteenth indicator 915b, and the nineteenth indicator 915c). According to an embodiment, the length of the seventeenth indicator 905 may be varied. For example, referring to FIG. 9E, when the distance between the electronic device 101 and the external electronic device falls within a predetermined distance (e.g., when the distance is short), the length of the seventeenth indicator 905 may be reduced as compared with its preset length. Referring to FIG. 9F, when the distance between the electronic device 101 and the external electronic device exceeds the predetermined distance (e.g., when the distance is large), the length of the seventeenth indicator 905 may be increased as compared with its preset length. Referring to FIGS. 9G and 9H, the shape of the seventeenth indicator 905 may be varied depending on the state in which the electronic device 101 is placed (e.g., the posture of the electronic device 101). For example, when the electronic device 101 is positioned in parallel with the ground (e.g., when the electronic device 101 is placed on the ground), the seventeenth indicator 905 may be displayed as attached to the ground. In this case, the sixteenth indicator 915a may be displayed on the electronic device 101. While the seventeenth indicator 905 is displayed as attached to the ground, the seventeenth indicator 905 may also be displayed as indicating the sixteenth indicator 915a. According to an embodiment, when a lifting of the electronic device by the user is detected, the electronic device 101 may display the sixteenth indicator 915a and the seventeenth indicator 905 as shown in FIG. 9C.

The electronic device according to certain embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic device is not limited to the above-listed embodiments.

It should be appreciated that certain embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

As is apparent from the forgoing description, according to an embodiment, it is possible to provide a user interface for the user to intuitively identify the location and direction of a target device for receiving at least one object when at least one object is shared with an external electronic device via short-range communication.

The effects set forth herein are not limited thereto, and it is apparent to one of ordinary skill in the art that various effects may be disclosed herein.

While the disclosure has been shown and described with reference to certain example embodiments thereof, it will be understood by those skilled in the art that various changes in form and details may be made therein without departing from the disclosure as defined by the appended claims and their equivalents.

What is claimed is:

1. An electronic device, comprising:
a communication circuit;
a touchscreen display; and
a processor, configured to:
receive a request to share at least one object via the touchscreen display;
identify at least one external electronic device proximate to the electronic device in response to receiving the request;
display, via the touchscreen display, at least one indicator representing the identified at least one external electronic device, wherein when a plurality of external electronic devices are identified, a plurality of representative indicators are displayed according to a predetermined priority;
detect a selection of the at least one indicator via the touchscreen display; and
in response to detecting the selection of the at least one indicator, transmit the at least one data object to the identified at least one external electronic device via the communication circuit.

2. The electronic device of claim 1, wherein the processor is configured to:
identify a direction and distance of the at least one external electronic device relative to the electronic device,
detect that the external electronic device is disposed outside of a predetermined angle range of the electronic device, and
display location information for the at least one external electronic device disposed outside of the predetermined angle range based on the identified direction and distance.

3. The electronic device of claim 1, wherein when the external electronic device is disposed within a predetermined angle range of the electronic device, the indicator is displayed as to correspond to a real-world position of the at least one external electronic device relative to the electronic device.

4. The electronic device of claim 2, wherein when the external electronic device is disposed outside the predetermined angle range of the electronic device, the location information based on the identified direction and distance is displayed with the indicator.

5. The electronic device of claim 1, wherein the priority includes at least one of a distance of each of the plurality of external electronic devices from the electronic device, a count of sharing requests for each of the plurality of external electronic devices, inclusion or exclusion of each of the plurality of external electronic devices in a predetermined angle range, and a property of the at least one data object.

6. The electronic device of claim 1, wherein the indicator further includes a transmission state of the at least one data object.

7. The electronic device of claim 1, wherein the processor is configured to provide different user interfaces depending on a property of the at least one external electronic device.

8. The electronic device of claim 7, wherein the at least one external electronic device is at least partially controllable through the user interface.

9. The electronic device of claim 1, wherein the processor is configured to:
display a filter selectable to display indicators corresponding to a first predetermined type of electronic device, and exclude from display indicators corresponding to a second predetermined type of electronic device.

10. The electronic device of claim 1, wherein
when the plurality of external electronic devices are identified, at least two of the displayed plurality of representative indicators overlap one another.

11. A method for controlling an electronic device, the method comprising:
receiving a request to share at least one object via a touchscreen display of the electronic device;
identifying, by at least one processor, at least one external electronic device proximate to the electronic device in response to receiving the request;
displaying, via the touchscreen display, at least one indicator representing the at least one external electronic device, wherein when a plurality of external electronic devices are identified, a plurality of representative indicators are displayed according to a predetermined priority;
detecting a selection of the at least one indicator via the touchscreen display; and
in response to detecting the selection of the at least one indicator, transmitting the at least one data object to the identified at least one external electronic device via a communication circuit of the electronic device.

12. The method of claim 11, further comprising:
identifying a direction and distance of the at least one external electronic device relative to the electronic device,
detecting that the external electronic device is disposed outside of a predetermined angle range of the electronic device; and
displaying location information for the at least one external electronic device disposed outside the predetermined angle range based on the identified direction and distance.

13. The method of claim 11, wherein when the external electronic device is disposed within a predetermined angle range of the electronic device, the indicator is displayed as to correspond to a real-world position of the at least one external electronic device relative to the electronic device.

14. The method of claim 12, wherein when the external electronic device is disposed outside the predetermined angle range of the electronic device, the location information based on the identified direction and distance is displayed with the indicator.

15. The method of claim 11, wherein the priority includes at least one of a distance of each of the plurality of external electronic devices from the electronic device, a count of sharing requests for each of the plurality of external electronic devices, inclusion or exclusion of each of the plurality of external electronic devices in a predetermined angle range, and a property of the at least one data object.

16. The method of claim 11, wherein the indicator further includes a transmission state of the at least one data object.

17. The method of claim 11, further comprising providing different user interfaces depending on a property of the at least one external electronic device.

18. The method of claim 17, wherein the at least one external electronic device is at least partially controllable through the user interface.

19. The method of claim 11, further comprising display a filter selectable to display indicators corresponding to a first predetermined type of electronic device, and exclude from display indicators corresponding to a second predetermined type of electronic device.

20. The method of claim 11, wherein when the plurality of external electronic devices are identified, at least two of the displayed plurality of representative indicators overlap one another.
